(19) United States
(12) Patent Application Publication
(10) Pub. No.: US 2026/0318013 A1
(43) Pub. Date: Oct. 15, 2026

(54) COMPOSITE CONCRETE PAVER INCORPORATING RECARBONATED STEEL SLAG AND METHODS OF MANUFACTURING THEREOF

(71) Applicant: ALGOMA STEEL INC., Sault Ste Marie (CA)

(72) Inventors: John Ralph NACCARATO, Sault Ste Marie (CA); Mohammad Kashif REHMAN, Sault Ste Marie (CA)

(21) Appl. No.: 19/646,365

(22) Filed: Apr. 13, 2026

Related U.S. Application Data
(60) Provisional application No. 63/787,496, filed on Apr. 11, 2025.

(51) Int. Cl. E01C 5/06; C04B 7/02; C04B 18/06; C04B 20/00; C04B 20/02; C04B 28/04; C04B 40/02; C04B 111/00

(52) U.S. Cl. CPC E01C 5/065; C04B 7/02; C04B 18/067; C04B 20/008; C04B 20/0232; C04B 20/026; C04B 28/04; C04B 40/0281; C04B 2111/00019; C04B 2111/00068; C04B 2111/00215; C04B 2201/52

(57) ABSTRACT

A composite concrete paver is disclosed, having a base layer incorporating a recarbonated steel slag, and optionally having a top layer made of virgin concrete product. The base layer may have two or more sub-layers of different recarbonated steel slag compositions. The carbonated steel slag has a reduced iron oxide content of less than about 5% by mass. The composite concrete paver contains about 15%-25% of calcium carbonate by mass, and about 5%-10% of magnesium carbonate by mass. The composite concrete paver is capable of withstanding a compressive strength from 40 MPa to 60 MPa, and exhibits a water absorption of 6% or less by mass. Corresponding methods of manufacturing the composite concrete paver are also provided.

### RELATED APPLICATION

The present application claims priority from U.S. patent provisional application Ser. No. 63/787,496 filed Apr. 11, 2025, entitled “CAST CONCRETE PAVER MADE FROM RECARBONATED STEEL SLAG AND METHOD OF MANUFACTURING THEREOF”, the entire content of which is incorporated herein by reference.

### FIELD OF THE INVENTION

The present invention relates to the field of construction materials, specifically to cast concrete pavers designed for use in pavements, walkways, driveways, and other applications. In particular, the present invention is concerned with composite concrete pavers incorporating recarbonated steel slag and methods of manufacturing thereof.

### BACKGROUND OF THE INVENTION

Concrete pavers are widely used in construction due to their strength, versatility, and aesthetic adaptability. Conventional pavers are composed of a single homogeneous material, typically virgin Portland cement concrete, which demands substantial quantities of virgin aggregates and generates significant carbon dioxide emissions during cement manufacture.

Steel slag is generated as a by-product of both basic oxygen furnace (BOF) and electric arc furnace (EAF) steelmaking. BOF slag is typically richer in calcium oxide (CaO) and iron oxides, while EAF slag generally contains higher proportions of magnesium oxide (MgO) and silicon dioxide (SiO₂). Historically, steel slag has been landfilled at considerable environmental and economic cost, with global steel slag production estimated at 170-250 million metric tonnes annually. Despite its potential as a supplementary cementitious material (SCM), incorporation of steel slag into concrete has been hindered by two principal challenges: (i) the low volume of hydraulic phases limiting reactivity; and (ii) long-term volumetric instability caused by the hydration of free calcium oxide (f-CaO) and free magnesium oxide (f-MgO), which can cause cracking and structural failure in finished concrete products.

The use of steel slag as an aggregate or fine aggregate substitute in concrete pavers and paving applications has been known in the prior art. Abdelbary and Mohamed reference, cited in the information disclosure statement (IDS), demonstrated that pavers incorporating steel slag exhibit enhanced abrasion resistance. Liu and Guo reference, also cited in the IDS, showed that under elevated curing temperatures, steel slag aggregates bond strongly with hardened cement paste, yielding higher compressive strength. Rubio-Cintas et al. reference, further cited in the IDS, reported that steel slag can reduce early-age shrinkage cracking in concrete. Palankar et al., yet further cited in the IDS, demonstrated no long-term strength reversal in alkali-activated concrete containing steel slag coarse aggregates over one year. Olofinnade et al., also cited in the IDS, showed compressive strength gains of up to approximately 15% at 40% sand replacement with waste furnace slag in interlocking paving blocks. The American Society for Testing and Materials has issued standards for steel slag aggregates in bituminous paving mixtures (ASTM D5106), and standards bodies including BS 6717, IS 15658, and ASTM C936 address concrete interlocking paving units generally, the above noted standards being cited in the IDS.

In spite of the progress made by manufacturing of concrete pavers using steel slag, there is still a need in the industry for developing improved concrete pavers using steel slag, with higher strength and durability, and corresponding methods of manufacturing thereof.

### SUMMARY OF THE INVENTION

There is an object of the present invention to provide an improved concrete paver made from recarbonated steel slag.

There is another object of the invention to provide corresponding methods for manufacturing the improved concrete paver made from recarbonated steel slag.

The present invention discloses a cast concrete paver incorporating recarbonated steel slag. For example, the concrete paver may have a base layer incorporating recarbonated steel slag, and a top layer of virgin concrete product. Other arrangements for concrete paver structure are also possible, as will be described in the technical description below. The above noted structure of the concrete paver creates a high-performance, sustainable paver with reduced permeability, which prevents or retards leaching of chemicals from the base layer as well as provides a long term sequestration of carbon in the recarbonated steel slag.

In the embodiments of the invention, a concrete admixture incorporating the steel slag is first carbonated, significantly enhancing its strength and durability. Also the recarbonation process can utilize carbon dioxide captured directly from the air or from industrial emissions, thereby reducing atmospheric carbon dioxide or industrial carbon emissions. Thus, the composite paver provides long-term carbon storage which then can be recycled into new concrete products including pavers, ensuring permanent carbon sequestration.

Upon recarbonating the steel slag, formation of the paver can be executed using either a wet cast or dry cast method.

The paver composition of the embodiments of the present invention may comprise a single layer of recarbonated steel slag. Alternatively, the paver may comprise a base layer made from recarbonated steel slag from 10% to 90% by weight, with the top layer of virgin concrete product making up the balance to 100%. Furthermore, the base layer itself can be multilayered comprising different recarbonated steel slag compositions.

According to one aspect of the invention, there is provided a composite concrete paver, comprising: a base layer, comprising: recarbonated steel slag; a concrete mix; wherein the recarbonated steel slag and the concrete mix are mixed to form a base layer mixture, which is uniformly distributed throughout the base layer.

The composite concrete paver further comprises a top layer comprising a virgin concrete product. In the composite concrete paver, the base layer comprises two or more sub-layers (strata) of different recarbonated steel slag compositions.

In the composite concrete paver described above, an iron oxide, Fe₂O₃, content in the recarbonated steel slag is less than about 5% by mass.

In the composite concrete paver described above, the recarbonated steel slag further comprises calcium carbonate, CaCO₃, in an amount from about 15% to about 25% by mass of the total concrete mix, which is a sum of all materials forming the paver. Alternatively, calcium carbonate may constitute from about 15% to about 25% of the recarbonated steel slag.

In the composite concrete paver described above, the recarbonated steel slag further comprises magnesium carbonate, MgCO₃, in an amount from about 5% to about 10% by mass of the total concrete mix, which is a sum of all materials forming the paver. Alternatively, magnesium carbonate may constitute from about 5% to about 10% of the recarbonated steel slag.

In the composite concrete paver described above, the recarbonated steel slag further comprises silica, SiO₂, in an amount from about 10% to about 20% by mass of the total concrete mix, which is a sum of all materials forming the paver. Alternatively, silica me constitute from about 10% to about 20% of the recarbonated steel slag.

In the composite concrete paver described above, the recarbonated steel slag is from about 15% to about 30% by mass of the base layer mixture.

In the composite concrete paver described above, the base layer is from about 10% to about 90% by weight of the composite concrete paver; and the top layer makes up the balance to 100% by weight of the composite concrete paver.

In the composite concrete paver described above, the base layer is from about 70% to about 80% by weight of the composite concrete paver; and the top layer is from about 20% to about 30% by weight of the composite concrete paver.

The composite concrete paver described above has at least one of the following property: capable of withstanding a compressive strength from 40 MPa to 60 MPa; exhibiting a water absorption of 6% or less by mass.

In the composite concrete paver described above, the top layer comprises Portland cement, fine aggregates having a particle size of 0-4 mm, coarse aggregates having a particle size of 4-10 mm, and water at a water-to-cement ratio of from about 0.08 to about 0.10.

In the composite concrete paver described above, the base layer mixture further comprises one or more admixtures selected from the group consisting of fly ash, ground granulated blast furnace slag (GGBFS), silica fume, superplasticizers, air-entraining agents, hydrated lime, and polymer additives.

According to another aspect of the invention, there is provided a a method of manufacturing a composite concrete paver, comprising:
(a) crushing or granulating a steel slag to produce a pre-processed steel slag;
(b) reducing iron oxide content of the pre-processed slag to produce a refined steel slag, comprising calcium oxide;
(c) carbonating the refined steel slag, comprising exposing the refined steel slag to a carbon dioxide to cause a reaction of the calcium oxide with the carbon dioxide to form calcium carbonate, CaCO₃, thereby producing a recarbonated steel slag;
(d) forming a base layer of the composite concrete paver comprising the recarbonated steel slag.

In the method described above, the step (d) further comprises forming a base layer comprising the recarbonated steel slag, and forming a top layer comprising a virgin concrete product.

In the method described above, the forming the base layer further comprises forming two or more sub-layers of the base layer comprising different recarbonated steel slag compositions.

In the method described above, the step (b) comprises reducing the iron oxide content to less than about 5% by mass of the recarbonated steel slag.

In the method described above, the step (c) results in forming the calcium carbonate in an amount from about 15% to about 25% by mass of the total concrete mix, which is a sum of all materials forming the paver. Alternatively, calcium carbonate may constitute from about 15% to about 25% of the recarbonated steel slag.

In the method described above, the refined steel slag further comprises magnesium oxide, and the step (c) further causes a reaction of the magnesium oxide with carbon dioxide to form magnesium carbonate, MgCO₃, in an amount from about 5% to about 10% by mass of the total concrete mix, which is a sum of all materials forming the paver. Alternatively, magnesium carbonate may constitute from about 5% to about 10% of the recarbonated steel slag.

In the method described above, the step (a) comprises reducing the steel slag to a particle size below about 100 μm.

In the method described above, the step (d) comprises dry or wet moulding of the base layer followed by curing at a temperature of from about 20 °C to about 25 °C at a relative humidity from about 90% to about 95% for a period from about 7 to about 28 days.

In the method described above, the step (b) comprises one or more of: magnetic separation; physical gravity separation or sieving; and chemical leaching.

In the method described above, the carbon dioxide in the step (c) is sourced from direct air capture or from industrial process emissions.

Also the methods may include steps of recovering an iron-oxide concentrate using the iron-oxide concentrate to produce iron feedstock. In the methods described above, reducing the iron-oxide concentrate comprises hydrogen reduction producing water vapour as a by-product.

According to one more aspect of the present invention, there is provided a circular closed-loop carbon storage system comprising: carbonating a refined steel slag residual material with carbon dioxide to produce recarbonated steel slag residual material in which the carbon dioxide is chemically fixed as stable carbonate minerals; incorporating the recarbonated steel slag residual material into a base layer of a first concrete paver; retaining the sequestered carbon dioxide within the first concrete paver throughout its service life; and, at end of service life of the first concrete paver, recovering and processing the first concrete paver to produce recycled material retaining the carbonate mineralogy of the recarbonated steel slag residual material, and incorporating the recycled material into a second concrete paver, whereby the sequestered carbon dioxide is transferred into the second concrete paver without release to atmosphere.

In the circular closed-loop carbon storage system, the step of incorporating the recycled material into the second concrete paver is repeatable through successive generations of concrete pavers, such that the sequestered carbon dioxide is retained indefinitely within the construction materials cycle.

In the circular closed-loop carbon storage system, the carbon dioxide used in the carbonating step is sourced from one or both of direct air capture and industrial process emissions.

In the circular closed-loop carbon storage system in the event the first concrete paver is not recycled at end of service life, the sequestered carbon dioxide remains fixed within the stable carbonate minerals of the recarbonated steel slag residual material under normal disposal conditions and is not released to atmosphere.

Advantages of the embodiments of the present invention include (i) reduction of iron oxide content as a preparatory processing step to enhance carbonation reactivity of the slag residual; (ii) controlled accelerated mineral carbonation of the iron-oxide-reduced slag residual as a positive industrial process step; (iii) the use of recarbonated slag as a carbon sequestration medium within a concrete paver; (iv) a composite paver architecture comprising a recarbonated slag base layer preferably combined with a low-permeability virgin concrete top layer specifically designed to encapsulate the recarbonated material and prevent leaching; or (v) the use of composite paver as a component of a circular closed-loop carbon storage system in which sequestered CO₂ is transferred, without atmospheric release, into successor concrete products upon recycling at end of life.

Carbonation of calcium-and magnesium-bearing minerals offers a means to simultaneously address the volumetric instability concerns of the prior art and to permanently sequester carbon dioxide. In gas-solid carbonation, CO₂ reacts directly with CaO and MgO phases in slag to form stable carbonates (CaCO₃ and MgCO₃), thereby eliminating the expansion risk that the prior art could only manage through passive weathering. While the iron oxide content of untreated slag impedes carbonation efficiency and limits the utility of the carbonated product as a cementitious component, reducing iron oxide content prior to carbonation—and recovering the resulting iron-oxide concentrate as a valuable feedstock—is a further advantage of the present invention.

The recarbonation step may utilize carbon dioxide captured from direct air capture or from industrial process emissions, thereby reducing net atmospheric or industrial CO₂ emissions. The recarbonated steel slag residual, once incorporated into the paver, provides long-term solid-phase carbon storage: the CO₂ fixed as stable carbonate minerals during recarbonation remains chemically bound within the concrete matrix throughout the service life of the paver. When the paver reaches the end of its service life, the recarbonated slag residual it contains retains its carbonate mineralogy and may be crushed, processed, and incorporated as aggregate or cementitious material into a new concrete paver or other concrete product. In this manner, the sequestered CO₂ is not released but is carried forward indefinitely through successive generations of concrete products, constituting a circular closed-loop carbon storage system. This chain—industrial CO₂ captured, fixed into slag carbonates, locked into a paver, and transferred upon recycling into a successor paver—enables genuinely permanent carbon sequestration within the construction materials cycle.

Thus, an improved paver made from recarbonated steel slag, and methods of manufacturing therefor, have been provided.

### BRIEF DESCRIPTION OF THE DRAWINGS

Embodiments of the invention will be better understood and readily apparent to one of ordinary skill in the art from the following written description, by way of example only, and in conjunction with the drawings, in which:

Embodiments of the present invention will be further described with reference to the accompanying exemplary drawings, in which:

FIG. 1 illustrates a high-level paver formation process, in accordance with an embodiment of the present invention;

FIG. 2 illustrates exemplary paver formations;

FIG. 3 illustrates a paver comprising a single layer of recarbonated steel slag;

FIG. 4 illustrates a paver comprising virgin concrete blended mix and recarbonated steel slag;

FIG. 5 illustrated a paver constructed as a base layer of recarbonated steel slag and a top layer of virgin concrete product;

FIG. 6 illustrates a paver constructed as a top layer of virgin concrete product and a base layer of multiple steel slag strata of different thicknesses and different graded compressive strengths, with a bottom stratum of relatively high compressive strength and a top stratum of a lower compressive strength; and different thicknesses, in accordance with an embodiment of the present invention;

FIG. 7 FIG. 8 illustrates a multi-phase treatment of raw steel slag to produce recarbonated steel slag of sufficient compressive strength for manufacturing pavers of specified compressive strength while retaining carbon dioxide (CO₂) and recycling material following a paver' service life, in accordance with an embodiment of the present invention;

FIG. 8 illustrates a multi-phase treatment of raw steel slag to produce recarbonated steel slag of sufficient high compressive strength for manufacturing pavers of specified compressive strength while retaining carbon dioxide (CO₂) and recycling material following a paver' service life, in accordance with an embodiment of the present invention;

FIG. 9 illustrates a first phase of the multi-phase treatment of FIG. 8 where iron oxide content is removed from raw un-stabilised steel slag to produce refined steel slag which is then carbonized to realize recarbonated steel slag having a requisite compressive strength, in accordance with an embodiment of the present invention;

FIG. 10 illustrates a second phase of the multi-phase treatment of FIG. 8 where the recarbonated steel slag is further conditioned for manufacturing pavers;

FIG. 11 illustrates a third phase of the multi-phase treatment of FIG. 8 where, during the service life of a paver, carbon dioxide is locked and subsequent to the service life of the paver the steel slag content is conditioned for re-use;

FIG. 12 identifies compressive stress at selected points of the paver of FIG. 3 which comprises only recarbonated steel slag when subjected to an external weight and of the paver of FIG. 4 which comprises blended virgin concrete product and recarbonated steel slag;

FIG. 13 identifies compressive stress at selected points of the paver of FIG. 5 which is constructed as a base layer of recarbonated steel slag and a top layer of virgin concrete product;

FIG. 14 identifies compressive stress at selected points of the paver of FIG. 6 which is constructed as a top layer of virgin concrete product and a base layer of multiple steel slag strata of different thicknesses and different graded compressive strengths;

FIG. 15 illustrates a process of generating a design table relating compressive strength to carbonation concentration levels of the refined-carbonated steel slag and to depths of the steel slag layers of the pavers of FIG. 3, FIG. 5, and FIG. 6, or the blended virgin concrete and recarbonated steel slag of the paver of FIG. 4, the design table being used in an automated process for selecting carbonation concentration levels and depths of steel slag layers, in accordance with an embodiment of the present invention;

FIG. 16 illustrates a software module for determining requisite carbonation concentration levels and corresponding depths of layers of recarbonated steel slag, in accordance with an embodiment of the present invention;

FIG. 17 illustrates a system for determining design parameters based on input data characterizing constituent paver materials, in accordance with an embodiment of the present invention;

FIG. 18 illustrates four samples of recarbonated steel slag of different depths (different thicknesses) corresponding to reference depths of samples used for producing the design table of FIG. 15 which relates compressive strength of a layer of refined-carbonated steel-slag to depth of the layer and carbonation concentration;

FIG. 19 illustrates a method of forming sample sets to be subjected to a carbonation processes and compressive-strength tests, in accordance with an embodiment of the present invention;

FIG. 20 illustrates an implementation of the method of FIG. 19 to produce eight sample sets, of three samples each, of a same depth but different carbonation levels to be subjected to compressive-strength tests;

FIG. 21 illustrates produced sample sets ready for compressive-strength testing;

FIG. 22 illustrates results of compressive-strength testing of the sample sets illustrated in FIG. 21;

FIG. 23 illustrates applying conventional interpolation to determine comprehensive strength values corresponding to predefine concentration levels Q₁, Q₂, . . . , Q₈ from the results illustrated in FIG. 22;

FIG. 24, a design table determined from the implementation of the method of FIG. 19, illustrated in FIG. 21 and FIG. 23, for the four reference layer depths at eight concentration levels;

FIG. 25 illustrates dependence of the duration of CO₂ exposure yielding a concentration Qⱼ, 1≤j≤8, on layer depth where the requisite duration increases with depth; and

FIG. 26 illustrates overall paver strength as a function of concentration for consecutive SS-layer depths, and selection of a pair {depth, concentration} to realize a prescribed compressive strength; and

FIG. 27 illustrates determining a requisite carbon-concentration level and depth of the base layer of refined-carbonated based on a paver's compressive strength and a respective ground strength.

### DETAILED DESCRIPTION OF THE EMBODIMENTS OF THE INVENTION

### Reference Numerals

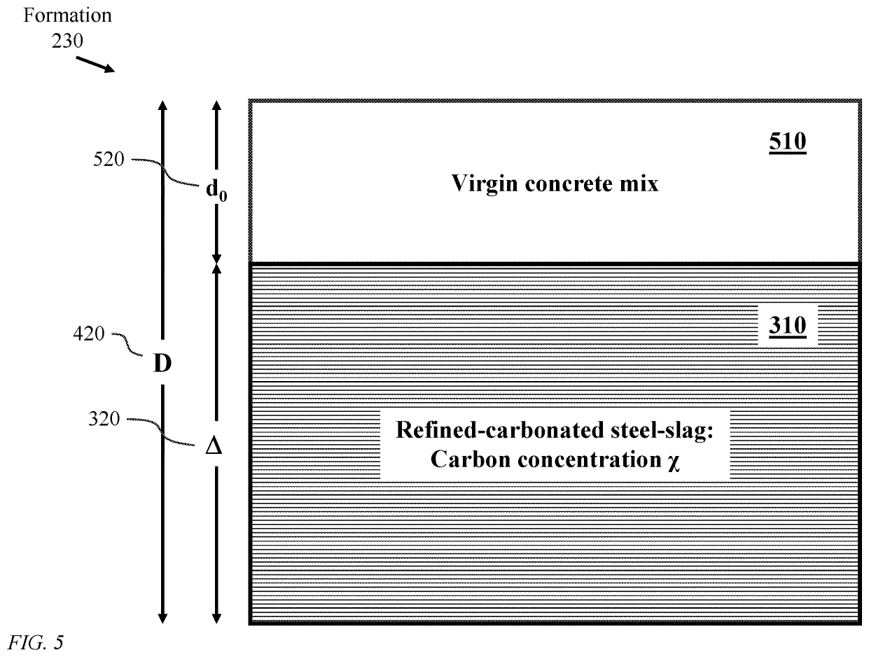

100: Basic paver-formation process
110: A source of granulated raw steel slag
120: A process of reducing iron oxide content of the granulated raw steel slag to produce a refined steel slag
130 A process of carbonating the refined steel slag to produce a carbonated-refined steel slag of higher compressive strength
140: A process of forming a paver of a specified thickness (depth) based on the carbonated-refined steel slag
200: Exemplary paver formations
210: A single layer of blended virgin concrete and refined-carbonated steel slag
220: An individual placement engine
230: A top layer of virgin concrete and a bottom layer of refined-carbonated steel slag
240: A top layer of virgin concrete and multiple layers of refined-carbonated steel slag
310: A single layer of refined-carbonated steel slag of a carbon concentration level sufficient to withstand a specified compressive strength
320: Thickness (depth) of the single layer determined to be sufficient to reduce the compressive stress exerted on the ground below the paver so as not to exceed the ground bearing strength
410: A single layer of blended virgin concrete and refined-carbonated steel slag of a carbon concentration level sufficient to withstand a specified compressive strength
420: Thickness (depth) of the blended layer determined to be sufficient to reduce the compressive stress exerted on the ground below the paver so as not to exceed the ground bearing strength
510: A top layer of virgin concrete
520: Thickness (depth) of the top layer
610: A top layer of virgin concrete
620: multi-stratum layer of refined-carbonated steel slag
621: A first stratum of refined-carbonated steel slag of a first carbon concentration χ₁
622: A second stratum of refined-carbonated steel slag of a second carbon concentration χ₂>χ₁
623: A third stratum of refined-carbonated steel slag of a third carbon concentration χ₃>χ₂
700: Accounting for both paver's base-layer strength and ground strength
800: Multi-phase formation of a composite paver using refined-recarbonated steel slag under a closed-loop carbon-storage requirement
810: Raw steel-slag processing and carbonation
820: Paver manufacture for the form of FIG. 5
830: Service-life CO₂ preservation and subsequent material recycling
840: recycled material
850: CO₂ retention
910: A source of raw, un-stabilised, steel slag
912: Crush of granularity less than 100 μm
920: A process of Fe₂O₃ reduction
922: Refined steel slag
930: A process of mineral carbonation
932: Recarbonated steel slag
940: Produced recarbonated steel-slag residual
1010: Base-layer mix of recarbonated steel slag, recycled paver content, sand, cement binder, and optionally Fly ash/GGBFS/silica fume
1020: Top-layer mix of virgin Portland cement/low water cement ratio/low permeability
1030: Moulding and curing
1040: Composite paver
1120: In-Service Paver
1140: Recycling after service life
1141: Recovery and processing
1142: Recycled material
1143: Successor paver
1210: Compressive stress in paver formation 210
1220: Compressive stress in paver formation 220
1300: Compressive stress in paver formation 230
1400: Compressive stress in paver formation 240
1500: Generating a design table for the paver of FIG. 5
1510: Selecting a sample-depth value
1520: Selecting carbon-concentration values
1530: Measuring compressive strength
1540: Forming a design table relating compressive strength to carbon concentration
1600: Determination of requisite level of carbonation
1610: Specified (requisite) compressive strength
1620: Specified base-layer depth boundaries (lower-bound and upper-bound of depth)
1630: An encoded interpolation module
1640: Target carbon concentration
1700: A system for determining design parameters
1710: A user-interaction module
1720: Software implementation of an algorithm for generating a design table
1730: Software implementation of an algorithm for computing paver's design parameters
1750: Inputs including a specified maximum external weight. paver-components specific-gravity values, and Paver's depth boundaries (lower and upper)
1760: Measurements of carbon concentration for different sample of refined-carbonated steel-slag
1770: Measurements of compressive-strength for different sample of refined-carbonated steel-slag
1790: Hardware Processor(s)
1800: Reference depths of samples of refined-carbonated steel slag denoted ₁, ₂, . . .
1900: A method of forming multiple sample-sets of different carbonation levels for compressive-strength measurements
1910: Selecting a reference depth
1920: Forming samples arranged into sample groups
1930: Subjecting all samples to a controlled CO₂ stream
1940: Isolating each sample sets after a respective duration of CO₂ exposure for further compressive-strength measurement
2000: Implementation of method 1900 to produce 8 sample sets of 3 samples (M=8, m=3) each to be exposed to the CO₂ streams over different exposure durations
2100: Produced carbonated sample sets to be subjected to compressive-strength measurements
2200: Results of compressive-strength measurements
2300: Interpolation of the compressive-strength measurements to determine compressive strength values corresponding to predefined reference concentration levels denoted Q₁, Q₂, . . . , Q₈
2400: A design table relating overall paver strength to carbon concentration for different depths (thicknesses)
2500: Illustration of dependence of requisite duration of CO₂ exposure yielding a specific carbon concentration level on the depth of a steel-slag layer
2600: Paver-strength versus carbon concentration for different paver depths
2610: Compressive strength versus carbon concentration for least base-layer depth
2620: Compressive strength versus carbon concentration for an intermediate base-layer depth
2630: Compressive strength versus carbon concentration for a greater base-layer depth
2640: Compressive-strength axis
2650: A first requisite compressive strength (to equal the highest expected compressive stress for a specific external weight)
2660: A second requisite compressive strength (to equal the highest expected compressive stress for a case of a lower external weight)
2700: Determining requisite carbon-concentration level and depth of the base layer of refined-carbonated based on a paver's compressive strength and a respective ground strength
2710: Compressive strength for different carbon-concentration levels χ₁, χ₂, χ₃, χ₄
2720: Ground stress
2730: Ground strength
2740: Highest compressive stress at the paver having a first base-layer depth
2750: Ground stress corresponding to stress 2740
2760: Highest compressive stress at the paver when the base-layer depth is increased
2770: Ground stress corresponding to stress 2760

### Terminology

In the present application, the terms “recarbonated steel slag”, “remineralized steel slag”, “carbonated steel slag” or “recarbonated steel slag residual material” are used interchangeably to refer to steel slag residual material that has undergone mineral carbonation to convert free CaO and MgO into stable carbonate minerals.

The terms “paver”, “composite concrete block”, “concrete block”, “concrete paver”, or “composite concrete paver” are also used interchangeably, and also will include various composite concrete products such as patio stones and concrete slabs.

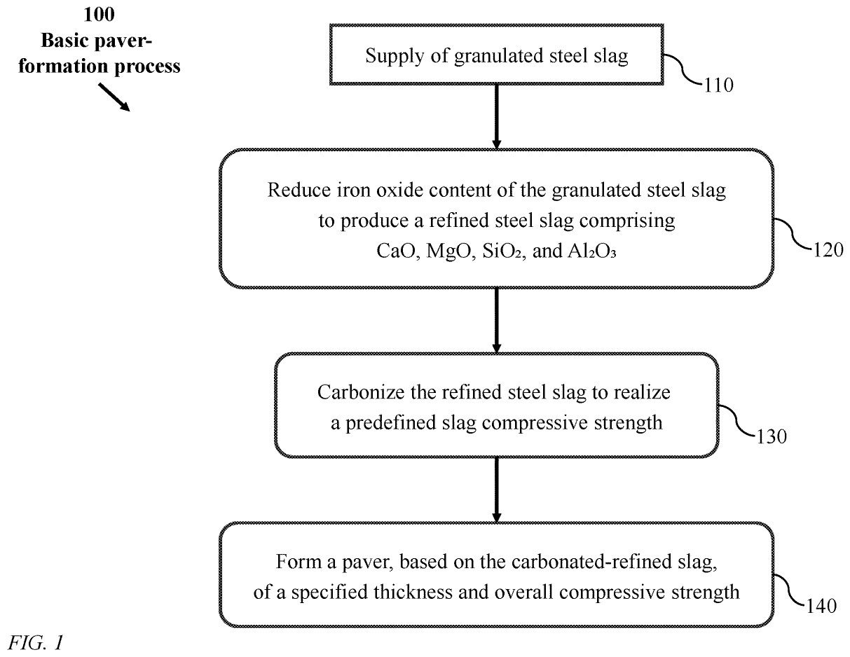

According to embodiments of the present invention, a base layer of the paver comprises recarbonated steel slag, which is formed by subjecting the pre-processed and then refined steel slag to a recarbonation process, as shown in FIG. 1. This process involves exposing the processed steel slag to CO₂, which reacts with the calcium oxide in the slag to form calcium carbonate, enhancing its strength and stability.

### Steel Slag Pre-Processing and Iron Oxide Reduction

As mentioned above, steel slag is produced as a byproduct during both basic oxygen furnace (BOF) and electric arc furnace (EAF) steelmaking processes, where fluxes such as lime and dolomite react with impurities in the liquid bath to form a solidified material. BOF slag is typically richer in calcium oxide (CaO) and iron oxides (FeO/Fe₂O₃), while EAF slag generally contains higher amounts of magnesium oxide (MgO), silicon dioxide (SiO₂), and may include more variable compositions depending on the feed materials. The steel slag is thereafter processed to produce a residual mixture which is more adaptable to be recarbonated using carbon dioxide from atmosphere or industrial process emissions.

The raw slag is first pre-processed by crushing or granulating it to a particle size below about 100 μm to obtain a pre-processed steel slag. It was determined that as slag particle size gets finer (<100 μm), iron oxide (FeₓO_{y}) content decreases substantially, while CaO and SiO₂ concentrations increase, enhancing carbonation reactivity.

Then the crushed pre-processed steel slag is further processed to remove iron oxides, to obtain a refined steel slag. Iron oxides has been removed from the slag matrix through one of known treatment methods, such as magnetic separation, physical gravity separation or sieving, or chemical leaching, thereby enhancing the suitability of the slag residual material as a supplementary cementitious material. Complete removal of iron oxides is not achievable, nor is it required; the objective is to reduce iron oxide content sufficiently to enhance carbonation reactivity and improve the utility of the slag residual as a cementitious component. After a steel slag has been remineralized and has undergone mineral carbonation, the composition of iron oxide content has been limited to less than about 5%.

The reduction of iron oxide content serves two purposes: it increases the proportion of reactive CaO and MgO available for carbonation, and it concentrates the iron-oxide fraction that may be further processed into iron feedstock by conventional blast furnace reduction or by hydrogen reduction technologies. Hydrogen-based reduction, producing water vapour rather than CO₂ as a by-product, offers a low-carbon pathway for iron briquette production from the recovered fraction.

The resulting refined slag residual material comprises mainly CaO-MgO-SiO₂-Al₂O₃ components. Prior to carbonation, the refined steel slag residual (after reducing iron content) has a preferred chemical composition of:
Calcium oxide (CaO): about 45-65% by mass;
Silicon dioxide (SiO₂): up to about 25% by mass;
Magnesium oxide (MgO): up to about 12% by mass; and
Residual metallic oxides: balance.

### Mineral Carbonation (Recarbonation)

The refined steel slag residual is subjected to mineral carbonation by exposure to carbon dioxide gas to produce recarbonated steel slag. Carbon dioxide may be sourced from direct air capture or from industrial process emissions. The chemical reactions are as follows:

CaO₃(s)+CO₂(g) →CaCO₃(s) (Equation 1)

MgO(s)+CO₂(g) →MgCO₃(s) (Equation 2)

Ca(OH)₂(s)+CO₂(g) →CaCO₃(s)+H₂O(l) (Equation 3)

Reaction kinetics may be enhanced by elevating reaction temperature, pressure, or CO₂ concentration. Gas-solid carbonation, involving only a gaseous CO₂ phase and the solid slag residual, is the preferred process as it avoids aqueous intermediates.

The remineralized steel slag, or recarbonated steel slag, includes calcium carbonate (CaCO₃), magnesium carbonate (MgCO₃), and silica (SiO₂) in its stabilized form, which are produced through the mineral carbonation process. By carbonating the steel slag, this process effectively reduces the potential for expansion caused by the hydration of free lime (CaO) and stabilizes silica, preventing it from contributing to volume instability when exposed to moisture or other environmental factors.

The recarbonated steel slag preferably has the following composition:
Calcium Carbonate (CaCO3): from about 15% to about 25% by mass from a total cement mix forming the composite cement paver, which enhances binder stability and carbonation resistance, reducing the risk of expansion. A particularly preferred range of calcium carbonate is from about 18% to about 22% by mass. At calcium carbonate contents below about 15% by mass, the degree of carbonation conversion of free CaO may be insufficient to fully eliminate volumetric expansion risk, and the carbon sequestration benefit of the recarbonated slag is correspondingly reduced. At calcium carbonate contents above about 25% by mass, the proportion of unreacted or partially reacted silicate phases available to contribute to cementitious strength development may be diminished, with a potential adverse effect on compressive strength of the finished paver. Within the preferred range from about 18% to about 22% by mass, the recarbonated steel slag exhibits both complete volumetric stabilization and sufficient contribution to the mechanical performance of the base layer, while maximizing the quantity of CO₂ permanently fixed within the paver as stable solid-phase carbonate. The calcium carbonate content within this preferred range also maximizes the carbon storage payload available for transfer into successor concrete products upon recycling at end of life, thereby optimizing the performance of the paver as a node within the circular closed-loop carbon storage system described herein.

Magnesium Carbonate (MgCO₃): from about 5% to about 10% by mass forming the composite cement paver, which provides chemical resistance and contributes to long-term strength and carbonation stability. A particularly preferred range of magnesium carbonate is from about 6% to about 8% by mass. At magnesium carbonate contents below about 5% by mass, conversion of free MgO and periclase phases may be incomplete, leaving residual expansive oxides that risk delayed volumetric instability in the finished paver under service conditions. At magnesium carbonate contents above about 10% by mass, the excess carbonate phases contribute disproportionately to the inert filler fraction of the base layer, reducing the net cementitious contribution of the recarbonated slag and diminishing compressive strength development. Within the particularly preferred range from about 6% to about 8% by mass, sufficiently complete conversion of expansive MgO phases is achieved while preserving the structural performance characteristics of the base layer. The magnesium carbonate content within this range further contributes to the carbon storage payload of the paver and to the transfer of sequestered CO₂ into successor concrete products within the circular closed-loop carbon storage system described herein.

Silica (SiO₂): from about 10% to about 20% by mass forming the composite cement paver, which reacts pozzolanically to generate calcium silicate hydrates (C-S-H), improving strength over time. A particularly preferred range for silica content is from about 13% to about 17% by mass. At silica contents below about 10% by mass, the pozzolanic contribution of the recarbonated steel slag to secondary calcium silicate hydrate (C—S—H) phase formation may be insufficient to achieve target compressive strength and long-term durability in the base layer. At silica contents above about 20% by mass, the elevated proportion of reactive silica increases the risk of alkali-silica reaction (ASR) with cement alkalis, potentially causing deleterious expansion and microcracking over the service life of the paver. Within the particularly preferred range from about 13% to about 17% by mass, the recarbonated steel slag provides sufficient pozzolanic contribution to cementitious strength development while maintaining ASR risk within acceptable limits consistent with the chemical resistance performance targets described herein.

Iron Oxide (Fe₂O₃): Limited to less than about 5% by mass of the carbonated steel slag, which helps control pigmentation while maintaining material strength and preventing undesirable color changes. A particularly preferred range of the iron oxide is from about 2% to about 4% by mass. Complete removal of iron oxide is neither achievable in practice nor required for the purposes of the present invention; the objective of the iron oxide reduction step is to reduce iron oxide content sufficiently to enhance carbonation reactivity of the CaO and MgO phases and to improve the utility of the slag residual as a cementitious component. At iron oxide content above about 5% by mass, residual iron oxide phases impede gas-solid carbonation kinetics by physically occluding reactive CaO and MgO surfaces, reducing carbonation conversion efficiency and limiting carbon sequestration yield. Within the particularly preferred range from about 2% to about 4% by mass, carbonation reactivity is sufficiently increased while the iron-oxide concentrate recovered during the iron oxide reduction step may be further processed as iron feedstock, including hydrogen reduction as described herein.

Other Components (for example, aluminum oxide, manganese oxide, minor impurities): about 5% to about 15% by mass, contributing to the overall structure and physical properties of the material. The recarbonated steel slag preferably contains aluminium oxide (Al₂O₃) in an amount of from about 5% to about 15% by mass of the recarbonated steel slag, with a particularly preferred range of from about 5% to about 10% by mass. Aluminium oxide participates in the formation of calcium aluminate hydrate (C—A—H) and calcium sulfoaluminate phases during curing, contributing to long-term strength development and chemical resistance of the base layer. At aluminium oxide contents below about 5% by mass, this supplementary phase formation is limited and the contribution of the recarbonated steel slag to the durability of the cured paver is correspondingly reduced. At aluminium oxide content above about 10% by mass, the elevated aluminate content may accelerate early hydration reactions and increase the risk of ettringite formation under sulfate exposure conditions, potentially compromising long-term dimensional stability. Within the particularly preferred range from about 5% to about 10% by mass, aluminium oxide contributes positively to C-A-H phase formation and chemical resistance while avoiding the adverse effects associated with elevated aluminate concentrations.

The total recarbonated slag content preferably comprises about 15% to about 30% by mass of the composite cement paver, partially replacing virgin aggregates and cement. Carbonation converts reactive free lime and periclase into stable carbonates, eliminating the volumetric expansion and cracking that would otherwise occur with uncarbonated slag in service.

The carbonation process of steel slag prevents the unwanted expansion typically caused by the presence of free lime (CaO) and other reactive components in uncarbonated slag. Through mineral carbonation, reactive oxides are transformed into stable carbonates (CaCO₃ and MgCO₃), significantly reducing the risk of volumetric expansion, cracking, or structural instability in the final paver.

Furthermore, the recarbonation process utilizes carbon dioxide captured directly from the air (direct air capture) or from industrial emissions prior to their release into the atmosphere, thus contributing to the reduction of industrial carbon emissions. The carbonation of calcium oxide or hydroxides may be completed using known methods.

### Base Layer Composition

The base layer of the composite paver is formed from the recarbonated steel slag combined with a virgin concrete/cement mix/mixture, including sand, Portland cement binder, and optional admixtures. The base layer preferably comprises from about 10% to about 90% by weight of the total paver, with the remainder made up by the top layer. However, in the embodiment where the paver contains a single layer only, without the top layer, the base layer is 100% by weight of the total paver.

To further enhance the structural properties and ensure proper bonding between the base layer (recarbonated steel slag) and the top layer (virgin cement mixture), various optional admixtures and binders can be incorporated into the cement/concrete mix of the base layer:
Fly ash: about 10-30% by mass of the cementitious component, to form additional calcium silicate hydrates (C—S—H) for improved strength and durability;
Ground granulated blast furnace slag (GGBFS): about 20-50% by mass, to enhance long-term strength and chemical resistance;
Silica fume: about 5-10% by mass, to increase compressive strength and reduce permeability;
Superplasticizers: about 0.5-2% by mass (or about 0.5-1% by cement weight), to reduce water demand and improve workability;
Air-entraining agents: about 0.05-0.1% by cement weight, to improve freeze-thaw resistance;
Hydrated lime: about 2-5% by mass, to provide calcium hydroxide for pozzolanic reactions; and
Polymer additives: about 1-3% by mass, to improve adhesion and environmental resistance.

These admixtures work synergistically to improve the performance of the concrete, ensuring optimal bonding, reduced expansion, and enhanced durability over time.

### Top Layer Composition

The recarbonated slag mixture can then be used either as a homogeneous paver or as a layered paver with a base layer of remineralized steel slag, and a top layer of virgin concrete materials for traditional aesthetics and surface performance properties. Typically, the top layer of virgin concrete mixture is a traditional concrete mix comprising Portland cement, aggregates, water, and optional admixtures.

In a preferred dry cast embodiment of forming the top layer, the top layer concrete mix comprises:
Cementitious Material, including Portland Cement (CEM I 42.5 N or similar): about 250-320 kg/m³.
Fine Aggregates (Natural Sand, 0-4 mm): about 700-850 kg/m³,
Coarse Aggregates (Crushed Stone, 4-10 mm): about 850-950 kg/m³, and
Water Content of about 25-30 liters/m³ (very low water content for a dry, zero-slump mix, approximately 0.08-0.1).

The virgin concrete layer provides a smooth, aesthetically pleasing surface that can be customized with various finishes, colors, and textures to meet specific design requirements.

This top layer of virgin concrete product is designed to have reduced permeability, thereby preventing or retarding leaching of any residual chemical species from the base layer and enhancing the environmental safety of the finished paver. The top layer may be customized with pigments, textured finishes, or surface treatments to meet specific architectural requirements.

### Paver Architecture

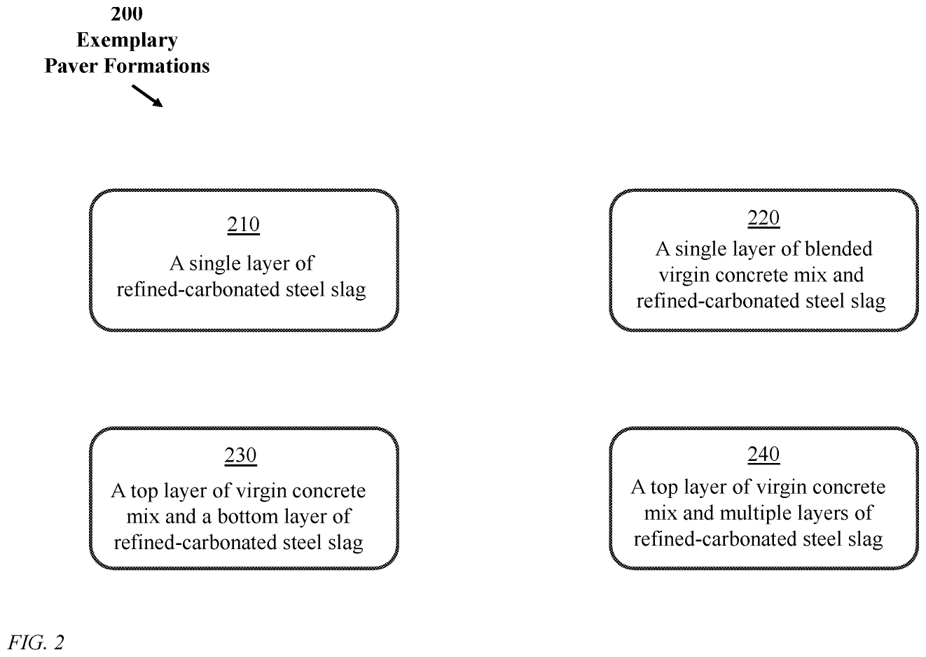

Exemplary paver formation options are schematically shown in FIGS. 2-6.

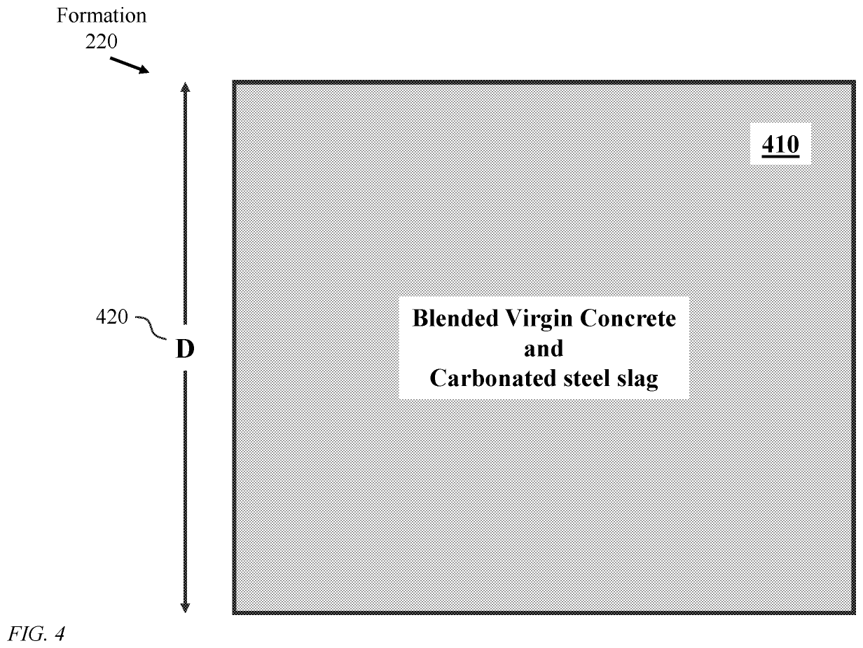

Homogeneous Configuration: In a first embodiment, shown in FIG. 4, recarbonated steel slag is uniformly blended throughout a single-layer paver, providing consistent structural and environmental performance across a full cross-section. This configuration is suitable for projects where uniform performance is desired and surface aesthetics are a lower priority.

Two-Layer Configuration: In a preferred embodiment, shown in FIG. 5, the paver comprises a base layer and a top layer as described above. In a preferred typical dry cast two-layer paver, the base layer constitutes approximately 70-80% of total paver mass, providing structural strength and carbon sequestration, while the top layer constitutes approximately 20-30% and provides the finished surface.

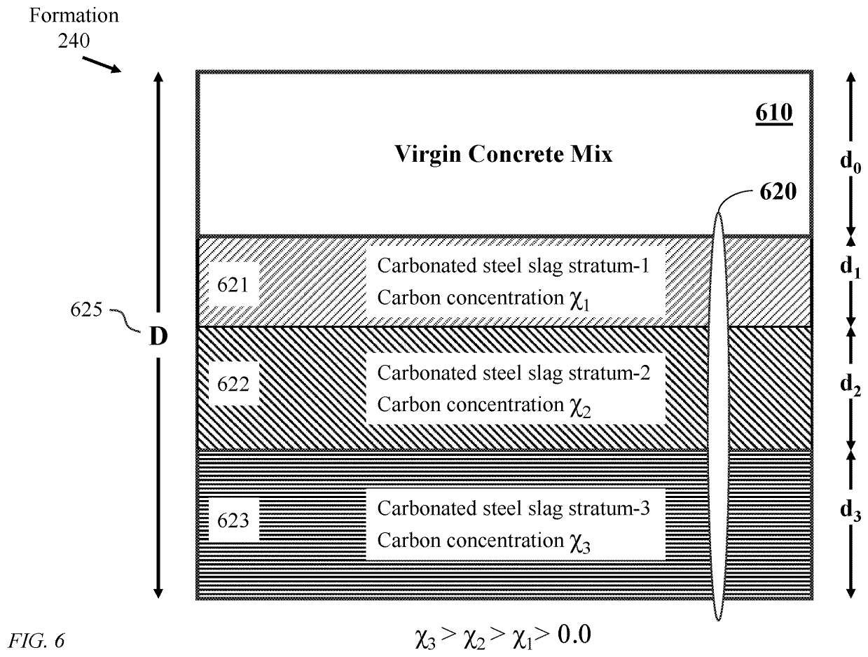

Multi-Layer Base Configuration: In a further embodiment, shown in FIG. 6, the base layer itself comprises two or more sub-layers (strata) of differing recarbonated steel slag composition, each sub-layer optimized for a specific function such as load-bearing capacity, drainage, or thermal resistance. Hereinafter, the terms “stratum” and “sublayer” are used interchangeably. This configuration permits fine-grained control of paver performance characteristics. For example, a denser, more durable sub-layer can be placed at the bottom to provide solid support, while the next sub-layer may incorporate more porous materials to allow for better water drainage or to improve weight distribution. Using two sub-layers in the base allows for a tailored approach to meet specific functional requirements while maintaining a strong, stable foundation.

### Manufacturing Process-Formation of Pavers

The manufacturing process begins with the preparation of the recarbonated steel slag base layer, as described above. The steel slag is first recarbonated and then mixed with binders and additives.

The prepared base layer material is cast into molds and compacted to form the base structure of the paver.

The paver formation method can utilize either a wet cast or dry cast method, depending on the desired properties and application of the paver. In the embodiments of the invention, the dry cast method is preferred due to its simplicity, high production rates and quality of pavers.

Dry cast method involves compacting a low-slump concrete mix of recarbonated steel slug and other additives into molds, which allows for high production rates and dense, durable pavers. This method typically results in concrete with a high density, which contributes to its strength and durability. A low water-to-cement ratio (approximately 0.08-0.10), zero-slump concrete mix is compacted into molds under vibration and high pressure (from about 40 MPa to about 80 MPa). Pavers are demolded immediately after compaction. This method achieves high production rates and yields dense pavers with optimal density of about 2.2 g/cm³ to about 2.5 g/cm³.

Higher density of dry cast pavers provides higher load-bearing capacity, abrasion resistance, and long-term performance, making dry cast pavers suitable for heavy-duty applications. The use of low-slump, stiff mixes also helps to reduce water content, leading to better workability and faster handling, while maintaining excellent surface finish and structural integrity.

To produce a multilayered paver using the dry cast process, the base layer and finish layer are created using a low-slump, dense concrete mixture that is compacted into molds sequentially, with the finish layer poured last. First, a low-slump concrete mix is poured into the mold to form the base layer, which is then compacted using high pressure or vibration to ensure a dense, durable structure. Once the base layer is fully compacted and has set to provide structural integrity, the finish layer is poured over the base layer. The finish layer, made from a higher-quality, more flowable concrete mix, may contain pigments or special additives for aesthetic appearance and surface durability. After the finish layer is applied, the entire paver is compacted again to ensure proper bonding between the two layers, remove air pockets, and create a smooth, cohesive surface. The paver is then cured under controlled conditions, often in a humid or warm environment, to allow both layers to set together and achieve required strength and durability. This process results in a strong, durable paver with a high-performance base and an attractive, functional finish layer.

Wet cast method involves pouring a wet concrete mix into molds, allowing for intricate designs and smooth finishes. The wet cast method allows for the creation of concrete blocks with optimized shapes that enhance both functionality and performance. By incorporating interlocking features such as notches or grooves, blocks can fit together securely, improving structural stability and ensuring better connectivity between layers, such as when using recarbonated steel slag in the base layer. Designs with stackable features, including recessed areas or lifting points, can optimize transportation and storage, reducing handling risks. To minimize expansion risks due to moisture or carbonation, sloped or beveled edges can be integrated, while rounded or curved surfaces help distribute stress evenly. Additionally, textured or roughened surfaces can improve bonding between layers, ensuring better adhesion and overall material stability. For weight reduction and flexibility, hollow or modular blocks can be produced, offering easier handling and potential for better load distribution. Geometrically reinforced shapes, such as triangular or ribbed designs, can further improve the load-bearing capacity of composite cement blocks, making them suitable for both aesthetic and structural needs.

Wet cast method requires a higher water-to-cement ratio than the dry case method, where flowable concrete mix is poured into molds. For two-layer pavers, the base layer is poured first and allowed to partially set before the top layer is poured, and the combined assembly is compacted to eliminate air voids. Wet cast pavers are cured slowly under moist or humid conditions, yielding superior surface finish and long-term durability.

To produce a multilayered product using the wet cast process, both the base layer and top layer are formed using flowable concrete mixtures, poured either sequentially or in reverse order, depending on the desired outcome. First, a flowable concrete mix is poured into molds to create either the base layer or the top layer, which is allowed to partially set or cure to achieve some structural integrity, but without fully hardening. Once the layer has set sufficiently but remains plastic enough to bond, the other layer is poured over it. The top layer may contain higher-quality materials, additives, or pigments for aesthetic finishes, while the base layer provides the structural foundation. After both layers are poured, the layers are compacted to remove air pockets and ensure proper bonding between them. The entire product is then cured under controlled conditions, typically in a humid environment, to allow both layers to hydrate together, forming a cohesive and durable unit. This flexible method allows for the creation of a strong, stable multilayered product with both structural strength and aesthetic appeal, regardless of the order in which the layers are applied.

Curing: Following moulding, composite pavers produced either by dry cast method or wet cast method are cured at about 20-25 °C with relative humidity from about 90% to about 95% for a period from about 7 days to about 28 days. Steam curing may be employed to accelerate strength development. Curing conditions are controlled to promote complete hydration of the cementitious binders and to maintain the carbonation reactions within the recarbonated slag component.

### Common Paver Dimensions

Common paver dimensions for residential applications include:
Rectangular: 200 mm×100 mm×60 mm
Square: 200 mm×200 mm×60 mm
Hexagonal: 200 mm diameter×60 mm thick

Paver thickness preferably ranges from about 50 mm to about 80 mm, and may range from 30 mm to 100 mm depending on the intended application.

Layered Pavers are ideal for applications where aesthetics matter, such as:
Driveways: The robust base layer supports vehicular traffic, while the aesthetic top layer matches traditional pavers.
Patios, Walkways, and Garden Paths: Offers a visually appealing surface with enhanced environmental benefits.
Commercial and Public Spaces: Combines high performance with sustainable features for plazas and pedestrian areas.

It is understood that pavers may be have various shapes, in particular interlocking pavers. For example, triangular, hexagon, octagon, I-shape, V-shape, dumble, round dumble, fan, zigzag, wave, polyhex, circular etc.

It is also understood that apart from pavers, other concrete product may also be produced in accordance with embodiments of the present invention, for example, composite patio stones having thickness preferably from about 100 mm to about 150 mm, and up to about 200 mm, or composite concrete slabs having thickness from about 100 mm to about 300 mm for various applications including highway slabs.

### Performance Characteristics

The composite paver of the present invention achieves the following performance targets:
Compressive strength: about 40-60 MPa after about 8 days of curing;
Water absorption: about ≤6% by mass, ensuring freeze-thaw durability;
Expansion control: carbonation of free CaO and MgO into stable carbonates to eliminate the volumetric expansion risk associated with uncarbonated slag;
Chemical resistance: the recarbonated carbonate phases are chemically stable against sulfate, chloride, and alkali-silica reaction (ASR); and
Carbon sequestration: CO₂ is permanently fixed in solid carbonate form within the paver and is further retained if the paver is recycled into new concrete products at end of life.

### Circular Closed-Loop Carbon Storage

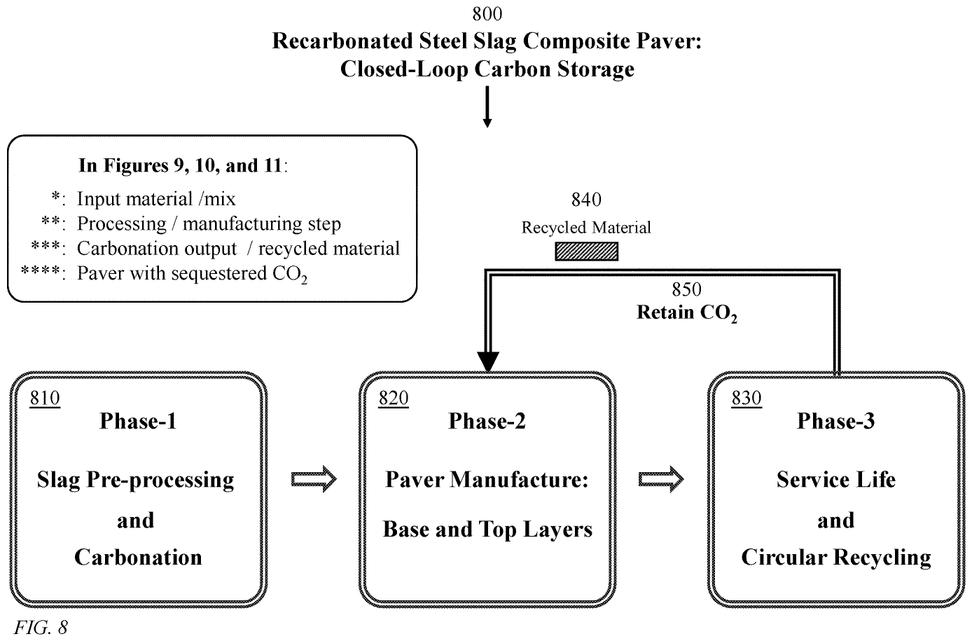

Embodiments of the present invention also provide a circular closed-loop carbon storage method and system is illustrated in FIGS. 8-11, by which carbon dioxide is permanently sequestered through an indefinitely repeating product lifecycle.

The carbon storage cycle operates as follows. First, carbon dioxide—sourced from direct air capture or from industrial process emissions that would otherwise be released to atmosphere—is reacted with the refined steel slag residual during the mineral carbonation step. The CO₂ is chemically fixed as stable solid calcium carbonate (CaCO₃) and magnesium carbonate (MgCO₃) within the slag matrix. These carbonates are thermodynamically stable under normal service conditions and do not revert to CO₂ and oxide phases without the application of temperatures well in excess of those encountered in service or in normal concrete recycling processes.

Second, the recarbonated steel slag is incorporated into the base layer of a composite concrete paver. Once cast and cured, the carbonate minerals are physically encapsulated within the concrete matrix, and the reduced permeability of the virgin concrete top layer further inhibits any environmental interaction with the base layer. The sequestered CO₂ remains locked in solid form throughout the paver's service life, which for concrete pavers in normal applications may be measured in decades.

Third, at the end of the paver's service life, the paver may be recovered and processed for reuse. Because the carbonate mineralogy of the recarbonated slag residual is stable through normal mechanical crushing and reprocessing, the recarbonated material retains its sequestered CO₂ when the paver is crushed and its aggregate or cementitious fractions are incorporated into a new concrete paver or other concrete product. The CO₂ is thereby carried forward into the successor product without release. This successor product is itself recyclable in the same manner, enabling the sequestered CO₂ to persist through successive product generations indefinitely.

In embodiments where the paver is not recycled at end of life—for example where it is sent to landfill—the sequestered CO₂ nonetheless remains fixed in the stable carbonate phases within the landfilled material and is not released to atmosphere under normal landfill conditions. Accordingly, carbon sequestration is maintained whether or not the recycling pathway is utilized, though the circular recycling pathway is preferred as it eliminates waste and maximizes the environmental and economic value of the recarbonated material.

The circular closed-loop carbon storage method and system of the present invention may be summarized as: (i) CO₂ capture via mineral carbonation of steel slag residual; (ii) encapsulation of the recarbonated slag within a concrete paver; (iii) long-term retention of sequestered CO₂ throughout paver service life; and (iv) transfer of the recarbonated material—and its sequestered CO₂—into a successor concrete product upon recycling, with step (iv) repeatable through successive product generations. This provides a permanent carbon sequestration pathway that converts an industrial waste stream into a durable carbon sink embedded within the built environment.

### Additional Embodiments

Additional embodiments will be further described with regard to FIGS. 1-27.

As mentioned above, FIG. 1 illustrates a basic paver-formation method 100 comprising:
preparing granulated steel slag 110 from raw steel slag (process 110);
reducing iron oxide content of the granulated raw steel slag to produce a refined steel slag (process 120) comprising CaO, MgO, SiO₂, and Al₂O₃;
carbonating the refined steel slag to produce a refined-carbonated steel slag of higher compressive strength (process 130); and
forming a paver of a specified thickness (depth) based on the refined-carbonated steel slag (process 140).

FIG. 2 illustrates exemplary paver formations 200 including: a single layer of refined-carbonated steel slag (form 210); a single layer of a blend of virgin concrete mix and refined-carbonated steel slag (form 220); a top layer of virgin concrete mix and a bottom layer of refined-carbonated steel slag (form 230); and a top layer of virgin concrete mix and multiple strata of refined-carbonated steel slag (form 240). Hereinafter, the terms “stratum” and “sublayer” are used interchangeably.

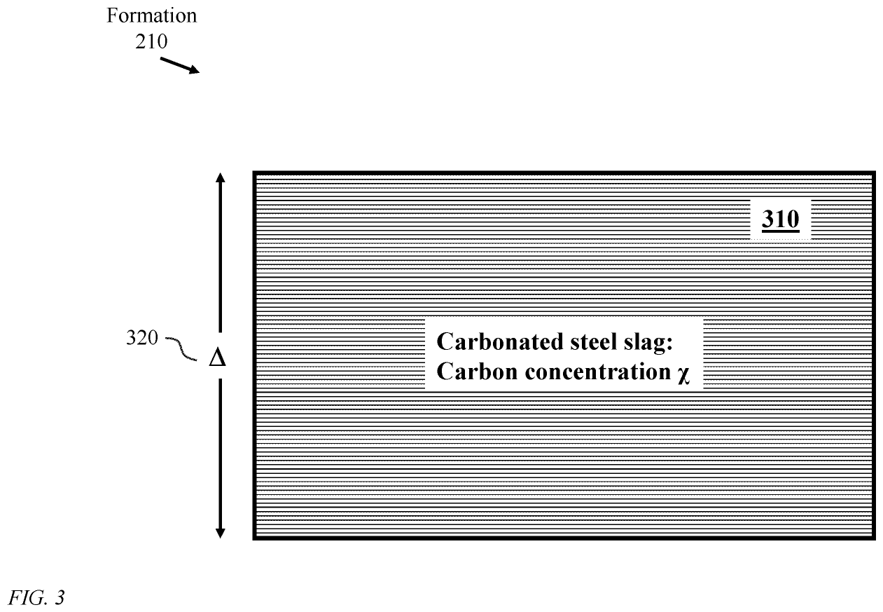

FIG. 3 illustrates a paver comprising recarbonated steel-slag (form 210) of a depth Δ and having a carbon concentration, χ. The single layer 310 comprises carbonated steel slag of a carbon concentration level sufficient to withstand a specified compressive stress. The carbon concentration χ is selected to yield a compressive strength equal to, or exceeding, a prescribed value. The depth (thickness), denoted Δ, is selected to yield a ground bearing stress not exceeding the ground bearing strength of ground supporting the paver. The ground bearing stress is the compressive stress exerted on the ground below the paver.

FIG. 4 illustrates a paver comprising a blend of virgin concrete mix and recarbonated steel slag in a single layer 410 (form 220) of depth D selected to yield a ground bearing stress not exceeding the ground bearing strength of ground supporting the paver. The carbon concentration level is selected to be sufficient to withstand a specified compressive stress.

FIG. 5 illustrated a paver constructed as a base layer 310 of incorporating recarbonated steel slag having a carbon concentration χ and a top layer 510 of virgin concrete mix of depth d₀ (form 23). The total depth (thickness) D, (D=Δ+d₀), is selected to yield a ground bearing stress not exceeding the ground bearing strength of ground supporting the paver.

FIG. 6 illustrates a paver constructed as a top layer 610 of virgin concrete mix, dept d₀, and a base layer 620 of multiple recarbonated steel-slag strata 621, 622, 623 (form 240) of different thicknesses (d₁, d₂, d₃) and different graded compressive strengths (0<χ₁<χ₂<χ₃) with the bottom stratum of a relatively high compressive strength and a top stratum of a lower compressive strength.

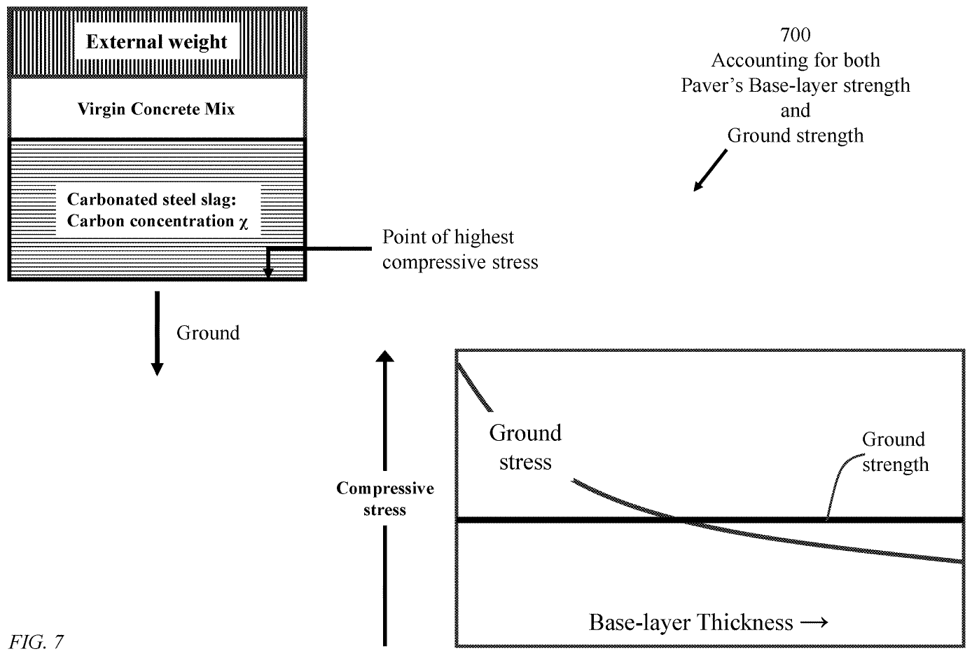

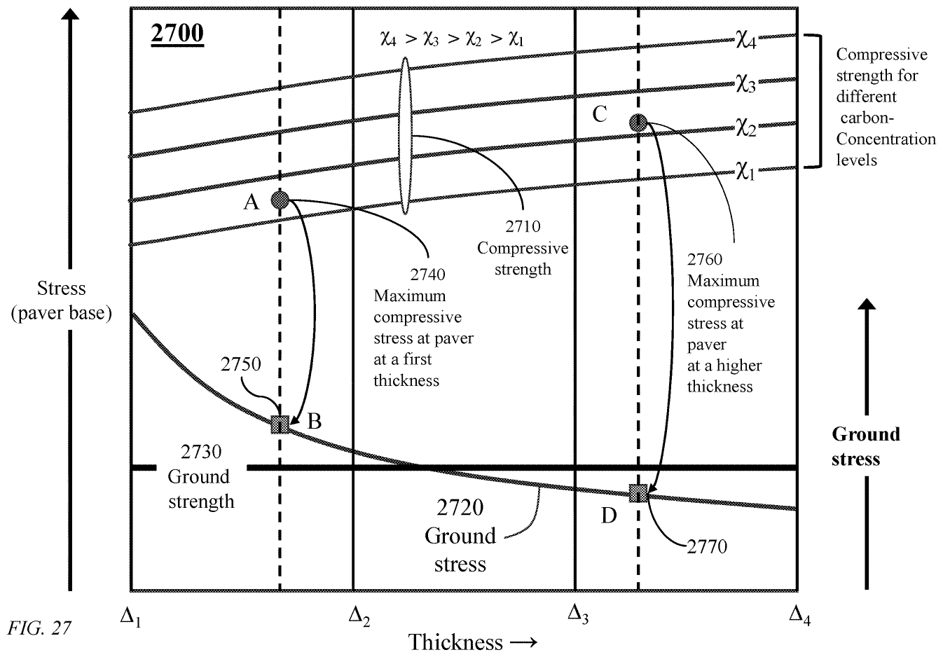

FIG. 7 illustrates a method for accounting for both paver's base-layer strength and ground strength in determining the requisite carbonation level and the depth of the base layer. The paver formation of FIG. 5 is used as an example. The highest compressive stress within the paver, under a given external load, occurs at the bottom of base layer of refined-carbonated steel-slag. The ground stress depends on the depth (thickness) of the paver where the ground stress decreases when the depth increases (despite the minor increase of weight of the paver due to the depth increment). As described in FIG. 27, the requisite carbon-concentration level and the depth of the base layer of recarbonated steel slag are determined based on a paver's compressive strength and a respective ground strength.

With respect to the processes of FIG. 8 to FIG. 11, the preferred ranges and performance targets are as listed below, as already mentioned above.

### Preferred Ranges:

CaCO3 18-22% (of total concrete mix)
Mg CO₃ 6-8% (of total concrete mix)
SiO₂ 13-17% (of total concrete mix)
Al₂O₃ 5-10% (of recarbonated steel slag)
Fe₂O₃ 2-4% (of recarbonated steel slag)

### Performance Targets

Compressive strength: 40-60 MPa
Water atmosphere: 6%
Curing: 7-25 days, 90-95% RH
Service life: Decades

FIG. 8 illustrates a multi-phase treatment 800 of raw steel slag to produce recarbonated steel slag of sufficiently high compressive strength for manufacturing pavers of specified compressive strength while retaining carbon dioxide (CO₂) and recycling material following a paver' service life. In phase-1, reference 810, raw steel-slag is pre-processed and carbonated. In phase-2, reference 820, pavers of form 230, FIG. 5, are manufactured. In phase-3, CO₂ is retained during the service life of pavers for reuse (reference 850) and specific materials are recycled (reference 840) following the service life.

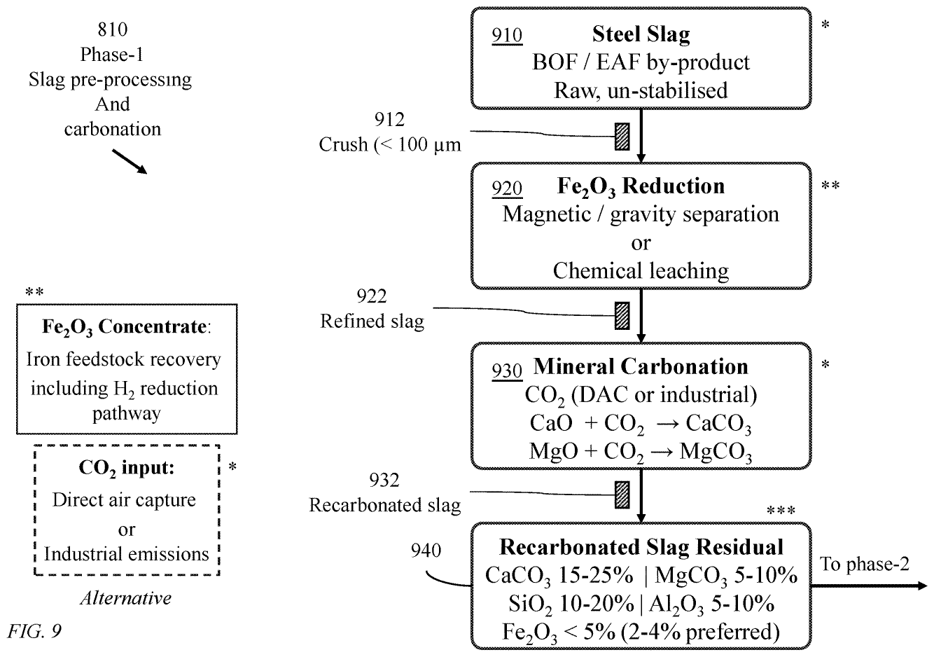

FIG. 9 details phase-1, 810, of the multi-phase treatment of FIG. 8 where iron oxide content is removed from raw un-stabilised steel slag to produce refined steel slag which is then carbonized to realize recarbonated steel slag having a requisite compressive strength. Processes of phase-1 include:
acquiring source of raw, un-stabilised, steel slag, 910 and producing crush of granularity less than 100 μm, 912;
reducing Fe₂O₃, 920, to produce refined steel slag, 922; and
mineral carbonation, 930, to produce recarbonated slag, 932.

The outcome of phase-1, is recarbonated steel-slag residual 940.

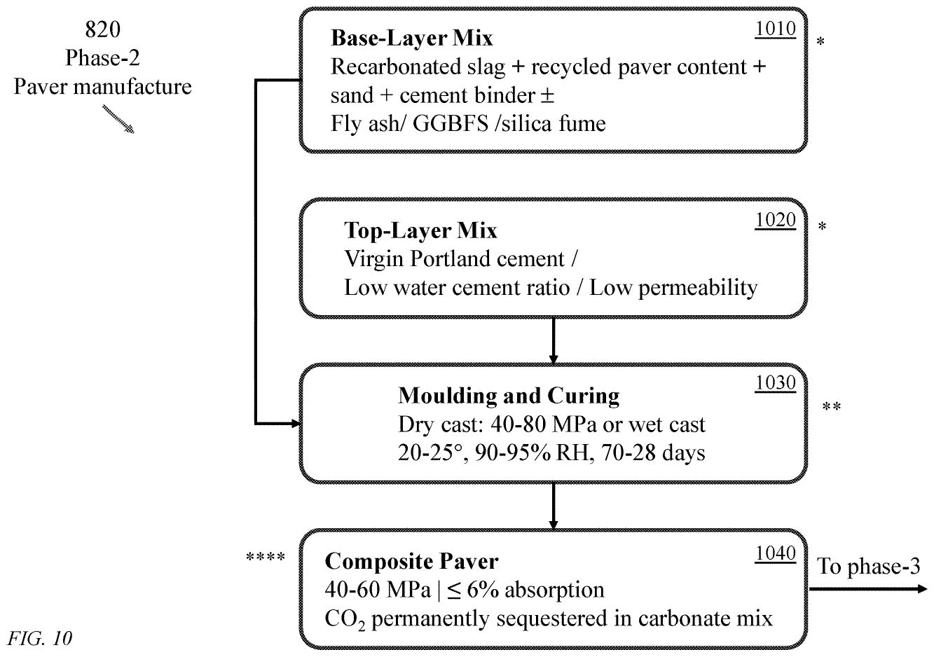

FIG. 10 details phase-2, 820, of the multi-phase treatment of FIG. 8 where the recarbonated steel slag is further conditioned for manufacturing pavers. Processes of phase-2 include:
base-layer mixing, 1010, of recarbonated steel slag, recycled paver content, sand, cement binder, and optionally Fly ash/GGBFS/silica fume;
top-layer mixing, 1020, of virgin Portland cement/low water cement ratio/low permeability;
moulding and curing, 1030; and
producing composite pavers. 1040.

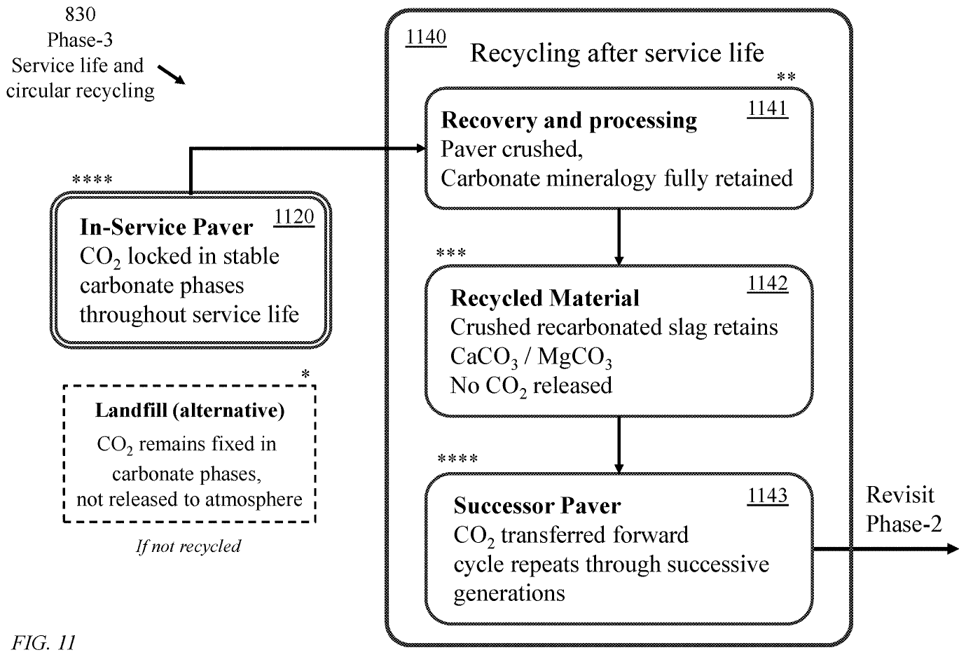

FIG. 11 details phase-3, 830, of the multi-phase treatment of FIG. 8 where, during the service life of a paver, carbon dioxide is locked and subsequent to the service life of the paver the steel-slag content is conditioned for re-use. Processes of phase-2 include:
while pavers are in-service, 1120, locking CO₂ in stable carbonate phases; and
following service life, 1140, performing recycling processes.

The recycling processes comprise:
recovery and processing, 1141, where pavers are crushed and carbonate mineralogy are fully retained;
processing recycled material, 1142, so that crushed recarbonated slag retains CaCO₂ and MgCO₃ with no release of CO2; and preparation for successor pavers, 1143, including transferring CO2 and ongoing recycling.

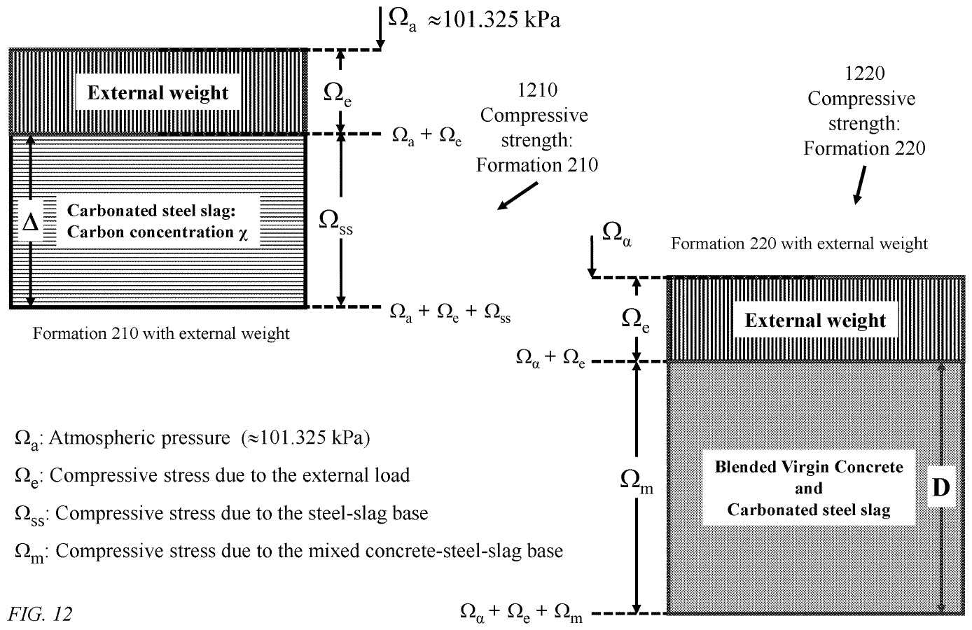

FIG. 12 identifies compressive stress at selected points of paver 210 of FIG. 3, which comprises only processed steel-slag, when subjected to an external weight and compressive stress at selected points of paver 220 of FIG. 4, which comprises a blend of virgin concrete mix and recarbonated steel slag, when subjected to an external weight.

Referring to the compressive-stress components 1210, relevant in paver 210, the compressive stress components comprise:
atmospheric pressure Ωₐ (101.325 kPa, relatively insignificant);
compressive stress Ωₑ due to the weight of external weight (most relevant); and
compressive stress Ωₛₛ due to the weight of the refined-carbonated steel-slag layer.
   The compressive stress at any point at the bottom of the recarbonated steel slag layer 310 is determined as (Ωₐ+Ωₑ+Ωₛₛ) which should not exceed the compressive strength of the recarbonated steel slag layer 310. The compressive strength of layer 310 depends mainly on the carbon concentration within the recarbonated steel slag layer.

Referring to the compressive-stress components 1220 relevant in paver 220, the compressive stress components comprise:
Ωₐ and Ω_{b} defined above, and
compressive stress Ωm due to the blend of virgin concrete mix and the rearbonated steel slag layer.

The compressive stress at any point at the bottom of the blend of virgin concrete mix and the recarbonated steel slag layer 410 is determined as (Ωₐ+Ωₑ+Ωₘ) which should not exceed the compressive strength of the mixture 410.

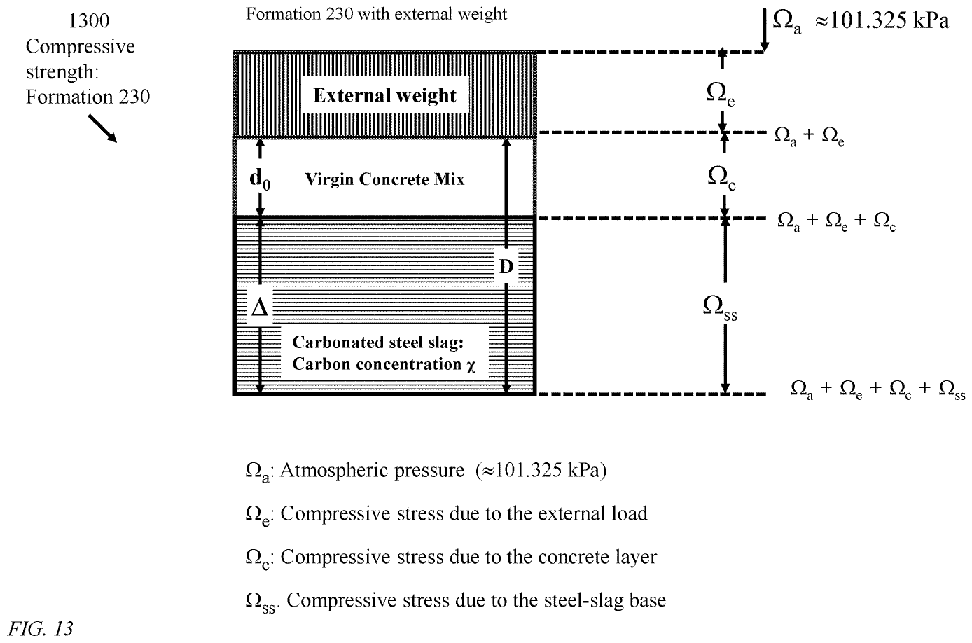

FIG. 13 identifies compressive stress components 1300 at selected points of paver 230 of FIG. 5, which is constructed as a base layer 310 of recarbonated steel slag and a top layer 510 of virgin concrete mix, when subjected to an external weight. The compressive stress components comprise:
Ωₐ and Ωₑ Defined Above,
Compressive stress Ω_{c} due to the weight of the concrete layer 510; and
Compressive stress Ωₛₛ due to the weight of the recarbonated steel slag layer.
   The compressive stress at any point at the bottom of the recarbonated steel slag layer 310 is determined as (Ωₐ+Ωₑ+Ω_{c}+Ωₛₛ) which should not exceed the compressive strength of the refined-carbonated steel-slag layer 310. The compressive strength of layer 310 depends mainly on the carbon concentration level within the recarbonated steel slag layer.

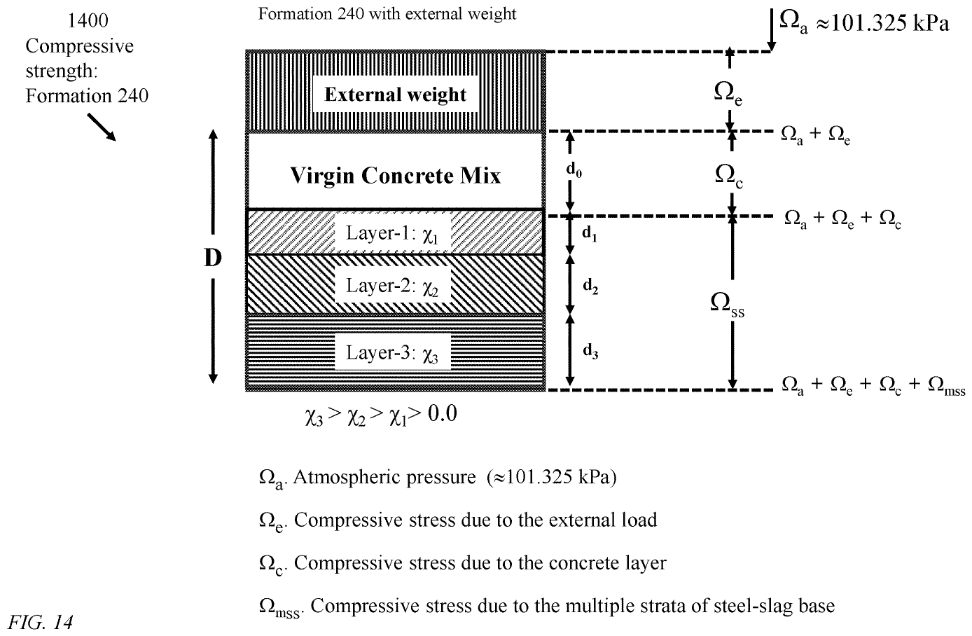

FIG. 14 identifies compressive stress components 1400 at selected points of paver 240 of FIG. 6, which is constructed as a top layer of virgin concrete mix and a base layer of multiple steel-slag strata of different thicknesses and different graded compressive strengths, when subjected to an external weight. The compressive stress components comprise:
Ωₐ, Ωₑ, and Ω_{c} defined above, and
Compressive stress Ωₘₛₛ due to the weight of the multiple strata of refined-carbonated steel-slag layer.

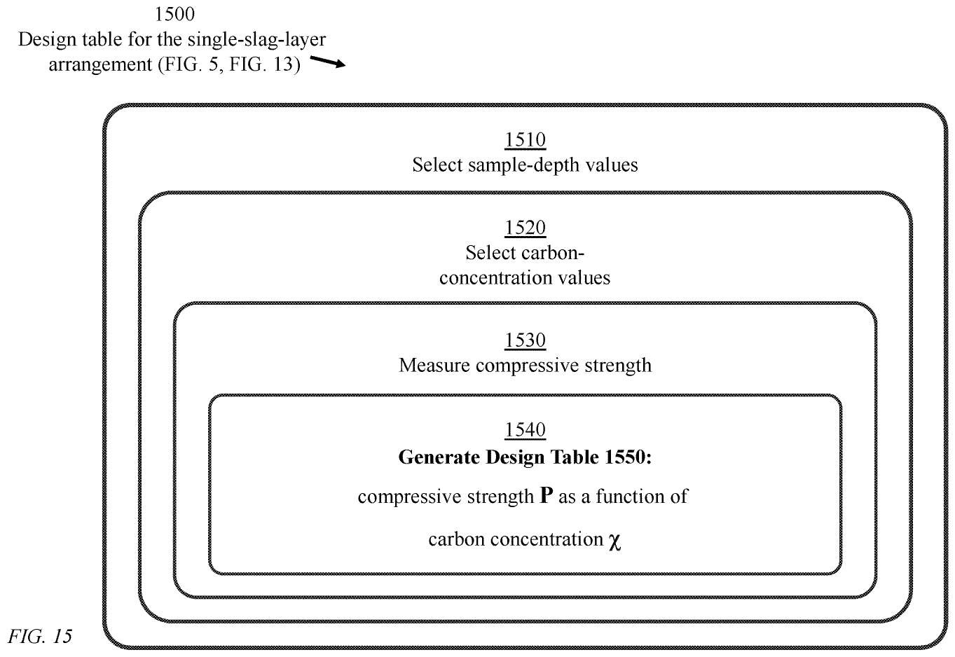

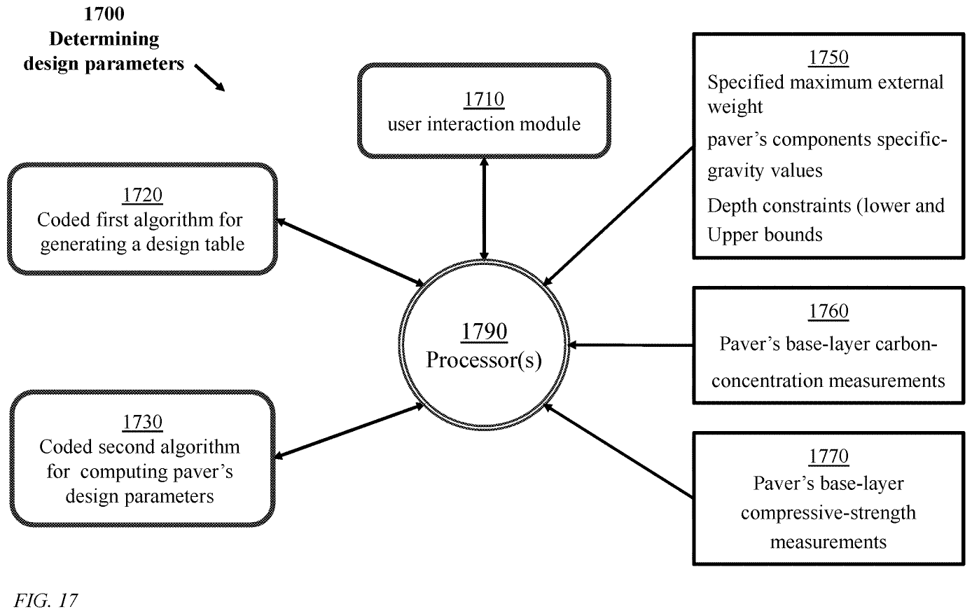

FIG. 15 illustrates a method 1500 of generating a design table relating compressive strength of the refined-carbonated steel slag to carbon concentration levels. It is understood that a cost function could be built instead of the design table. The design table is used in an automated process for selecting carbon concentration levels based on users'input (see FIG. 17). Process 1510 selects a value of the depth (thickness) of layer 310 of the refined-carbonated steel-slag (FIG. 3). Process 1520 generates a number of samples of carbon-concentration values of the selected depth. Process 1530 measures the compressive strength of each sample. Process 1540 forms a design table 1550 relating compressive strength to carbon concentration.

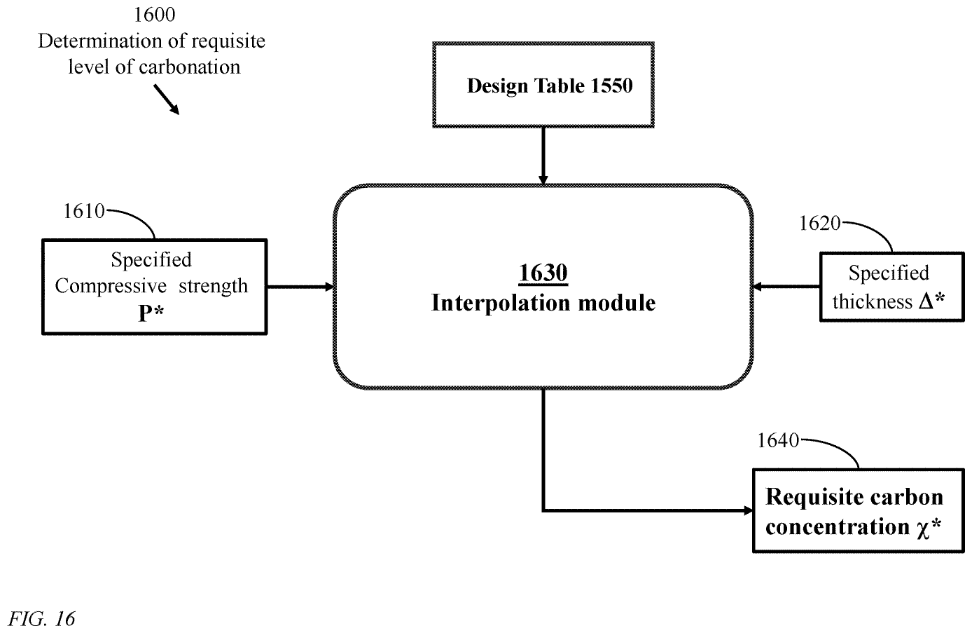

FIG. 16 illustrates an arrangement 1600 for determining a requisite carbon-concentration level 1640 of the recarbonated steel slag layer 310 of pavers 210 and 230 of FIG. 3 and FIG. 5, respectively. An interpolation module 1630 uses design table 1550, generated according to method 1500 of FIG. 15, to determine a carbon concentration level that realizes a specified compressed strength 1610 of a layer of a specified depth 1620 of recarbonated steel slag.

FIG. 17 illustrates a system 1700 for determining a paver's design parameters. A user-interaction module 1710 acquires from a user data relevant to:
Specified maximum external weight;
specific-gravity values of the virgin-concrete-mix and the recarbonated steel slag;
any constraints regarding lower and/or upper bounds of the depth of a sought paver;
measurements of carbon-centration levels of test samples of the recarbonated steel slag; and
measurements of ground strength (which may vary significantly from one region to another).

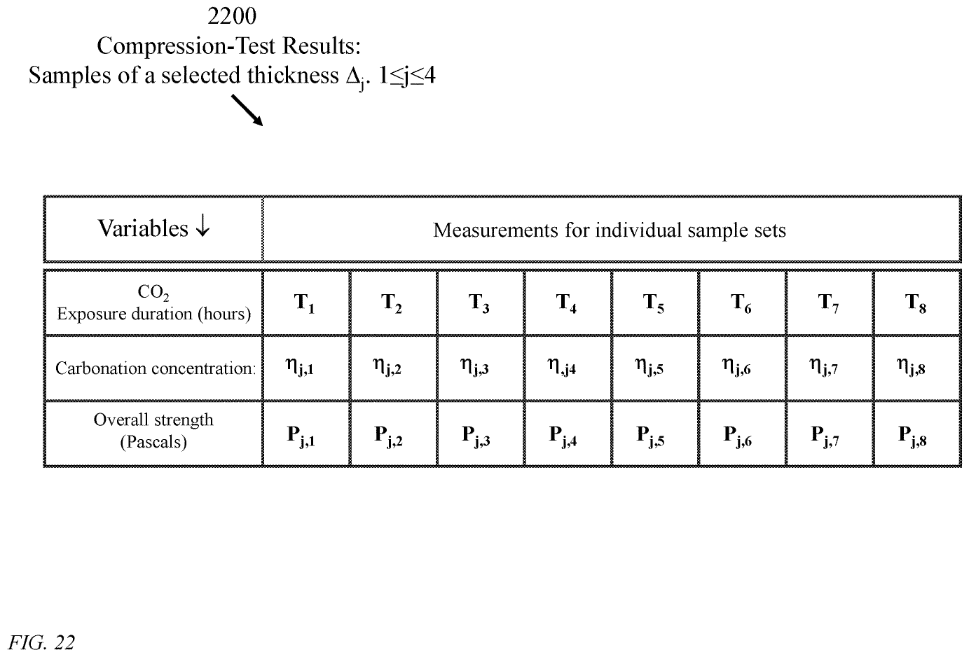

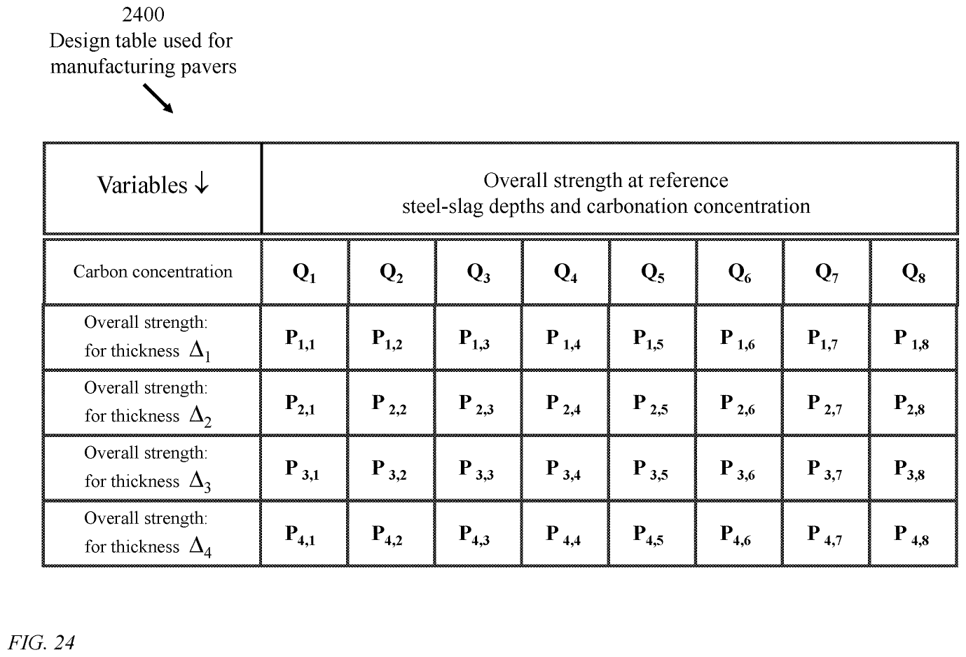

Software module 1720 implements a first algorithm (FIG. 15) for generating a design table (FIG. 22 and FIG. 24), or a corresponding function or cost function. Software module 1730 implements a second algorithm for computing paver's design parameters including a required carbonization level and thickness (depth) of the base layer of recarbonated steel slag.

A memory device 1750 stores the specified maximum external weight, specific-gravity values of the virgin-concrete-mix and the recarbonated steel slag, and any constraints regarding lower and/or upper bounds of the depth of a sought paver. A memory device 1760 stores measurements of carbon concentration for different samples of recarbonated steel slag. A memory device 1770 stores measurements of compressive strength for the samples of recarbonated steel slag. A processing unit 1790 may comprise a single hardware processor or an assembly of processors.

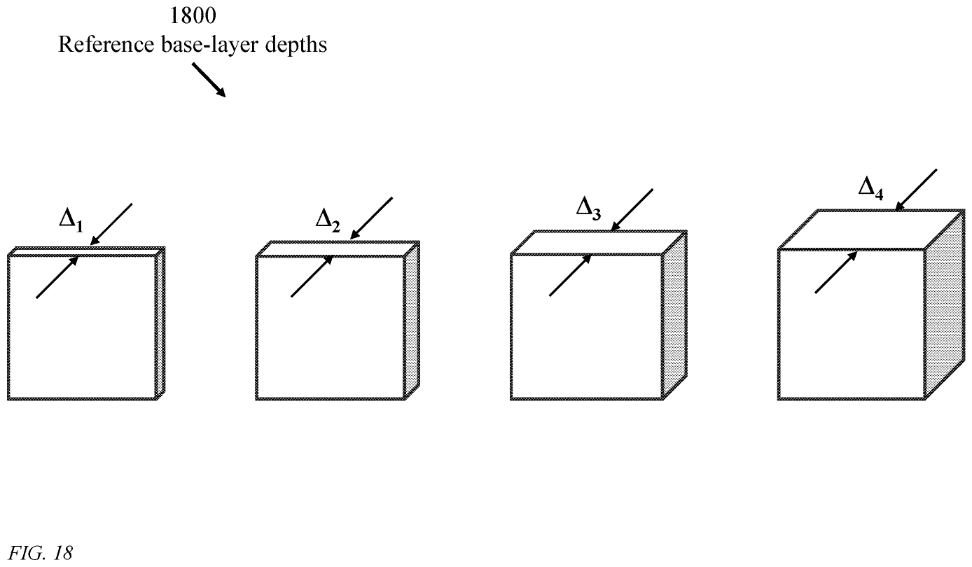

FIG. 18 illustrates four exemplary samples 1800 of recarbonated steel slag of different depths (different thicknesses) corresponding to reference depths of samples used for producing the design table of FIG. 15 which relates compressive strength of a layer of recarbonated steel slag to depth of the layer and carbonation concentration.

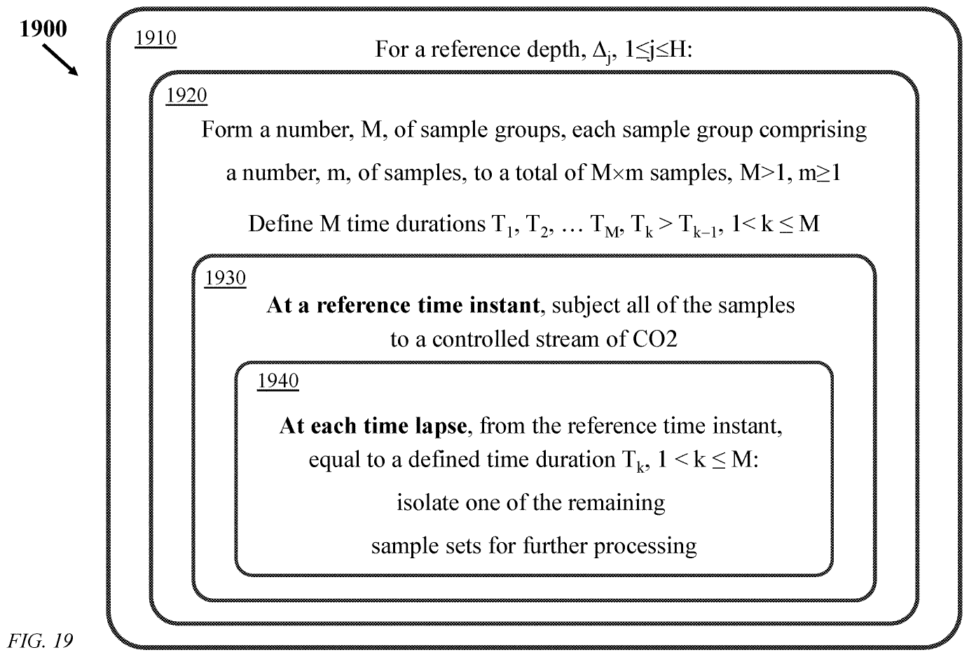

FIG. 19 illustrates a method 1900 of forming multiple sample sets to be subjected to a carbonation processes and compressive-strength testing to determine compressive-strength measurements. The method comprises nested processes. Process 1910 selects a reference depth. Process 1920 forms multiple samples arranged into sample groups. With M sample groups (M>1) each sampling group comprising m samples, m≥1, M time durations, denoted T₁, T₂, . . . , T_{M} are defined with Tₖ>Tₖ≤1, 1<k≤M. Process 1930 subjects all of the M×m samples to a controlled CO₂ stream. Process 1940 isolates each sample set after a respective duration of CO₂ exposure for further testing and compressive strength measurement.

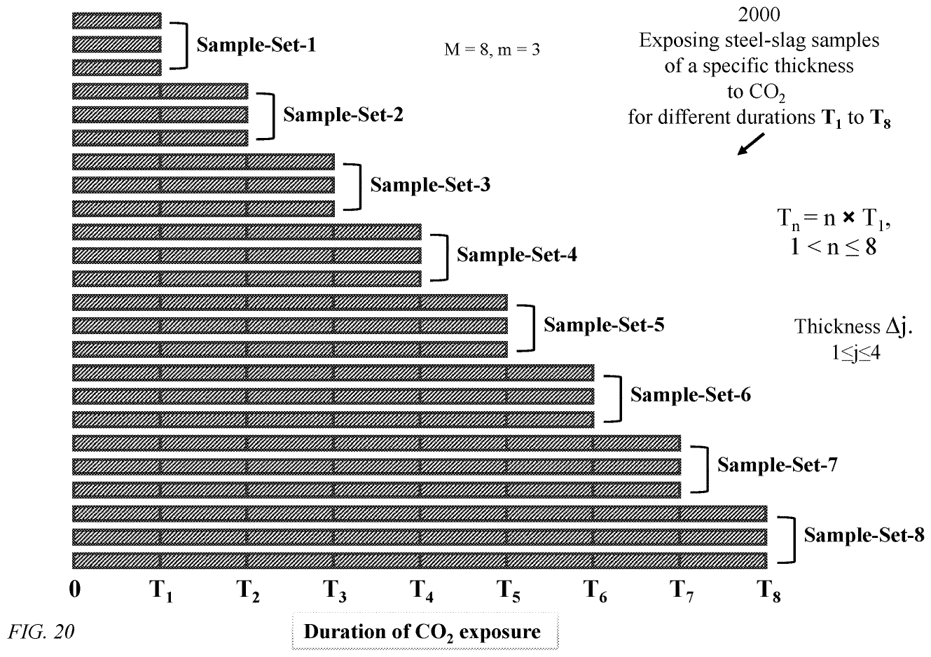

FIG. 20 illustrates an implementation of the method of FIG. 19 to produce eight sample sets, of three samples each (M=8, m=3), of a same depth to be exposed to a CO₂ stream over different exposure durations then subjected to compressive strength tests.

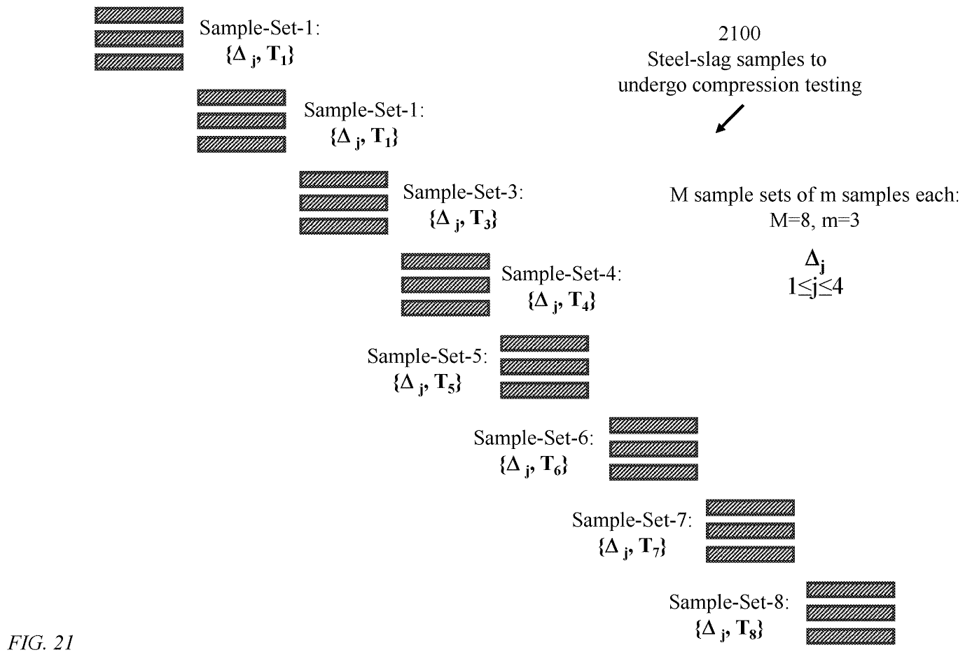

FIG. 21 illustrates produced carbonated sample sets 2100 ready for compressive strength testing.

FIG. 22 illustrates results 2200 of compressive strength testing of the sample sets illustrated in FIG. 21.

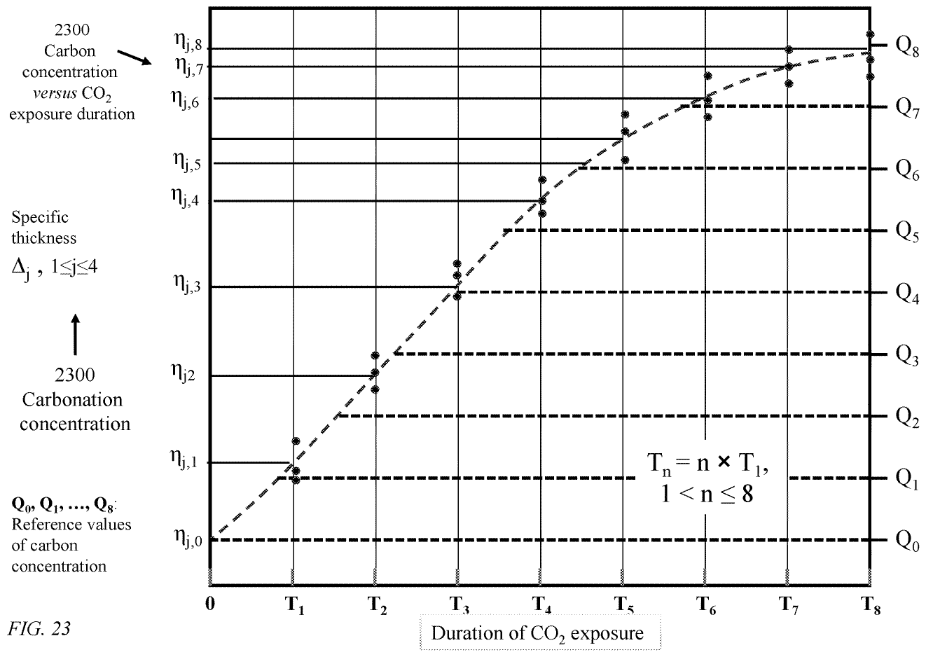

FIG. 23 illustrates applying conventional interpolation of the compressive-strength measurements to determine compressive strength values corresponding to predefined carbon concentration levels Q₁, Q₂, . . . , Q₈ from the results illustrated in FIG. 22. The figure illustrates a relation 2300 of carbon concentration versus CO₂ exposure duration.

FIG. 24 illustrates a design table 2400 determined from the implementation of the method of FIG. 19, illustrated in FIG. 23, for the four reference layer depths at eight carbon concentration levels. The design table (or a function) relates overall paver strength to carbon concentration for different depths (thicknesses).

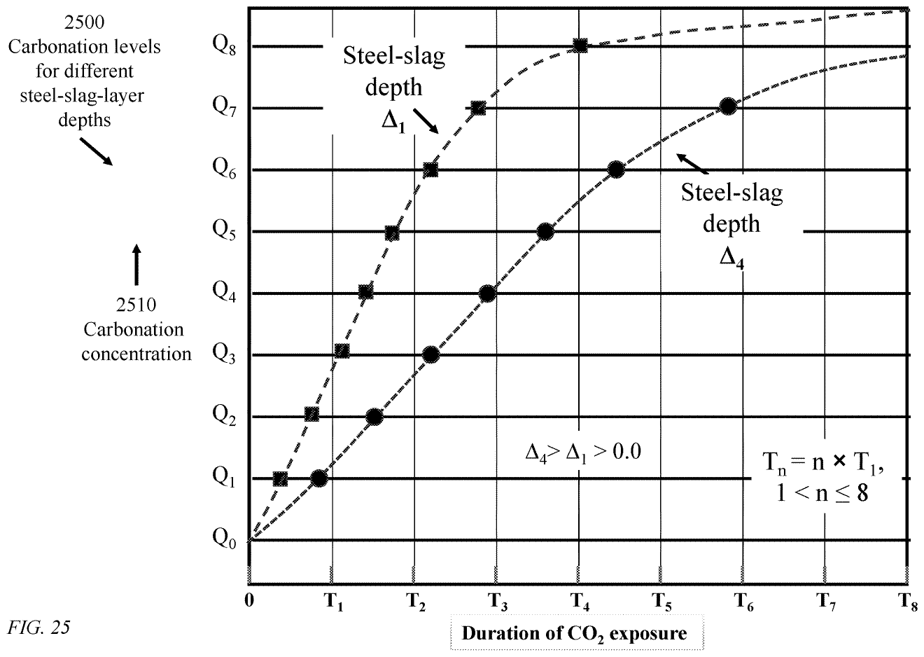

FIG. 25 illustrates charts 2500 relating dependence of the duration of CO₂ exposure yielding a concentration Qⱼ, 1≤j≤8, on layer depth where the requisite duration increases with depth.

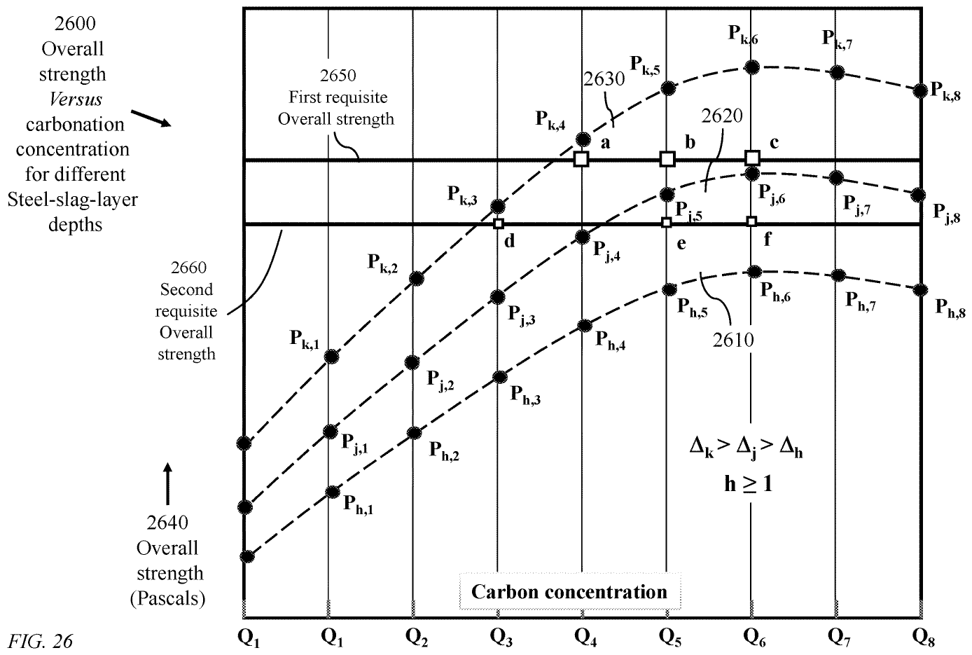

FIG. 26 illustrates a method 2600 used in algorithm 1730 for computing a paver's design parameters based on determining overall paver strength as a function of carbon concentration for consecutive steel-slag-layer depths, and selection of a pair {depth, concentration} to realize a prescribed compressive strength. The compressive strength versus carbon concentration within the base layer is plotted (2610, 2620, and 2630) for three values of base layer depth.

In a first paver, the requisite strength is determined to equal the value indicated (reference 2650). The compressive strengths P_{k,4}, P_{k,5} and P_{k,6} of plot 2630, corresponding to carbon concentrations Q₄, Q₅, and Q₆, respectively, exceed the requisite strength (compared with points a, b, and c). Thus, the lowest concentration Q₄ may be selected. In a second paver, the requisite strength is determined to equal the value indicated (reference 2660). The compressive strengths P_{k,3}, of plot 2630 and P_{j,5} and P_{j,6} of plot 2620, corresponding to carbon concentrations Q₃, Q₅, and Q₆, respectively, exceed the requisite (compared with points d, e, and f). Thus, the lowest concentration Q₃ may be selected.

The first requisite compressive strength at least equals the highest expected compressive stress for a specific external weight for a specific paver. The second requisite compressive strength at least equals the highest expected compressive stress for another paver supporting a lower external weight.

FIG. 27 details a method 2700 for determining a requisite carbon-concentration level and depth of the base layer of refined-carbonated steel-slag based on a paver's compressive strength and a respective ground strength. Compressive strengths, for different carbon-concentration levels χ₁, χ₂, χ₃, χ₄, are plotted against depths of the base layer of pavers (reference 2710). As well known, increasing the depth reduces the ground stress as illustrated (reference 2720).

Consider a case where the depth is between Δ₁ and Δ₂, the maximum compressive stress at the paver is below the compressive strength corresponding to carbon concentration χ₂ (point “A”, reference 2740) while the ground stress (point “B”, reference 2750) is higher than the ground strength 2730. The carbon concentration level is adequate but the depth of the base layer is insufficient. Thus, the depth needs to be increased to a value which yields a ground stress below the ground strength.

In the illustrated example, the depth is increased to a value between Δ₃ and Δ₄. The ground stress decreases to a value below the ground strength (point “D”, reference 2770). However, with the (relatively small) increase of the weight of the paver due to the thicker base layer, the maximum compressive stress at the paver increases (slightly) requiring increasing the carbon concentration (point “C”, reference 2760) to a value slightly larger than χ₂.

Methods and systems according to the embodiments described above are summarized below.

According to yet another aspect of the invention described above, there is provided a method of manufacturing pavers to support an external weight, the method comprising:
configuring each paver as a base layer of refined steel slag of thickness Δ and a top layer of a selected concrete type and a selected top-layer thickness;
forming a first number, M, M>2, of sample sets of the refined steel slag, each sample set comprising a respective number of samples each of thickness Δ;
exposing each sample set to a stream of carbon dioxide during a respective distinct duration;
measuring sample-set carbon concentration and sample-set compressive strength of each sample set to yield M values of carbon concentrations and corresponding M values of compressive stress;
establishing an analytical function relating compressive strength to carbon concentration; receiving an upper bound of the external weight;
determining peak compressive stress at said each paver based on the upper bound, and known specific gravities of the selected concrete type and the refined steel slag; and
establishing a requisite carbon concentration of the base layer corresponding to said peak value according to the analytical function.

The method further comprises carbonating the base layer to attain the requisite carbon concentration.

In the method, the sample-set carbon concentration is a mean value of carbon concentrations of individual samples of a respective sample set and the sample-set compressive strength is a mean value of compressive strength of individual samples of a respective sample set.

The method further comprises selecting the thickness Δ to be any of a number of prescribed thickness values.

According to one more aspect of the invention, there is provided a method for manufacturing pavers to support an external weight, the method comprising:
configuring each paver as a base layer of refined steel slag of thickness Δ and a top layer of a selected concrete type and a selected top-layer thickness;
forming a first number, M, M>2, of sample sets of the refined steel slag, each sample set comprising a respective number of samples each of thickness Δ;
exposing each sample set to a controlled stream of carbon dioxide during a respective distinct exposure duration;
measuring compressive strength of each sample set to yield M values of exposure duration and corresponding M values of compressive stress;
establishing an analytical function relating compressive strength to exposure duration; obtaining an upper bound of the external weight;
determining peak compressive stress at said each paver based on the upper bound, and
known specific gravities of the selected concrete type and the refined steel slag; and
determining a requisite exposure duration of the base layer according to the analytical function.

In the method described above, all of the samples are subjected to said controlled CO₂ stream and subsequently each sample set is isolated after a respective period of CO₂ exposure for further testing and compressive-strength measurement.

In accordance with yer one more aspect of the invention, there is also provided a system for manufacturing pavers to support an external weight, the system comprising:
means for configuring each paver as a base layer of refined steel slag of thickness Δ and a top layer of a selected concrete type and a selected top-layer thickness;
means for forming a first number, M, M>2, of sample sets of the refined steel slag, each sample set comprising a respective number of samples each of thickness Δ;
means for exposing each sample set to a stream of carbon dioxide during a respective distinct duration;
means for measuring sample-set carbon concentration and sample-set compressive strength of each sample set to yield M values of carbon concentrations and corresponding M values of compressive stress;
means for establishing an analytical function relating compressive strength to carbon concentration;
means for receiving an upper bound of the external weight;
means for determining peak compressive stress at said each paver based on the upper bound, and known specific gravities of the selected concrete type and the refined steel slag;
and
means for establishing a requisite carbon concentration of the base layer corresponding to said peak value according to the analytical function.

The system further comprises means for carbonating the base layer to attain said requisite carbon concentration.

In the system described above, the sample-set carbon concentration is a mean value of carbon concentrations of individual samples of a respective sample set and said sample-set compressive strength is a mean value of compressive strength of individual samples of a respective sample set.

The system further comprises selecting said thickness Δ to be any of a number of prescribed thickness values.

According to yet one more aspect of the invention, there is provided another system for manufacturing pavers to support an external weight, the system comprises:
means for configuring each paver as a base layer of refined steel slag of thickness Δ and a top layer of a selected concrete type and a selected top-layer thickness;
means for forming a first number, M, M>2, of sample sets of the refined steel slag, each sample set comprising a respective number of samples each of thickness Δ;
means for exposing each sample set to a controlled stream of carbon dioxide during a respective distinct exposure duration;
means for measuring compressive strength of each sample set to yield M values of exposure duration and corresponding M values of compressive stress;
means for establishing an analytical function relating compressive strength to exposure duration;
means for receiving an upper bound of the external weight;
means for determining peak compressive stress at said each paver based on the upper bound, and known specific gravities of the selected concrete type and the refined steel slag;
and
means for determining a requisite exposure duration of the base layer according to the analytical function.

In the system described above, all of the samples are subjected to said controlled CO₂ stream and subsequently each sample set is isolated after a respective period of CO₂ exposure for further testing and compressive-strength measurement.

### Advantages

Using recarbonated steel slag processed to remove iron oxides as a concrete admixture offers several distinct advantages compared to traditional aggregates. Traditional aggregates are sourced from natural materials such as crushed stone, gravel, and sand, which are composed of silicates, quartz, and other naturally occurring minerals. These materials are extracted and processed, often leading to habitat destruction and increased carbon emissions. In contrast, recarbonated steel slag is a by-product of steel manufacturing, primarily from the basic oxygen steelmaking process. It consists mainly of calcium silicates and other mineral oxides, with the iron oxides removed during processing. This utilization of industrial waste not only reduces the need for natural resource extraction but also provides an environmentally friendly recycling solution.

The properties and performance of these two types of aggregates also differ significantly. Traditional aggregates have a moderate density and generally good durability, with adequate compressive strength for most construction needs. They are typically chemically inert, with low reactivity in the concrete mix. Recarbonated steel slag, on the other hand, has a higher density, which contributes to increased concrete mass and potential strength. It is highly durable due to the recarbonation process, which enhances its structural integrity. The dense and robust nature of the slag can significantly increase the compressive strength of concrete. Moreover, the recarbonation process stabilizes the slag, reducing its reactivity and potential for expansion, which improves long-term durability.

Recycling steel slag through the recarbonation process offers significant environmental benefits by both reducing the need for landfilling and decreasing the consumption of virgin aggregates. When steel slag is carbonated, it undergoes a chemical transformation in which carbon dioxide (CO₂) reacts with the calcium oxide (CaO) and magnesium oxide (MgO) in the slag to form stable carbonates like CaCO₃ and MgCO₃, effectively capturing CO₂ in a solid form. This process mitigates the environmental impact of CO₂ emissions by sequestering carbon, thus contributing to efforts in combating climate change.

By recycling steel slag through this method, the need to dispose of the material in landfills is minimized, reducing both the space required for waste storage and the potential for harmful leachates. In addition, the use of recarbonated slag in construction materials, such as concrete or as a substitute for virgin aggregates, reduces the demand for extracting natural resources like sand, gravel, and crushed stone, which often have environmental impacts associated with mining. This conservation of natural resources helps to preserve ecosystems, reduce habitat destruction, and lower energy consumption involved in the extraction and transportation of virgin aggregates.

Overall, the recarbonation of steel slag offers a sustainable solution that reduces waste, lowers carbon emissions, and conserves natural resources, contributing to a more circular economy in the construction and materials industries.

The benefits or advantages of the present invention can be summarized with the following performance characteristics:
Compressive Strength: 40-60 MPa after 28 days, with strength gains resulting from the carbonation of CaCO₃ and MgCO₃.
Durability: Magnesium carbonate and calcium carbonate improve resistance to chemical attack (e.g., sulfate resistance), while silica enhances long-term strength through pozzolanic reactions. The recarbonated slag content minimizes the risk of expansion, which is a common issue with uncarbonated steel slag.
Expansion Control: The carbonation process stabilizes the reactive components in steel slag, significantly reducing the risk of expansion and cracking due to free lime (CaO) or periclase (MgO) in uncarbonated slag.
Carbon Sequestration: The use of recarbonated steel slag in the mix results in permanent carbon sequestration, enhancing the environmental sustainability of the paver.
Water Absorption: Low water absorption (≤6%) ensures excellent freeze-thaw durability and performance in moisture-prone environments.

Recarbonated calcium and magnesium from processed steel slag offer several advantages over traditional virgin materials mined from quarries, particularly in terms of sustainability, material properties, and performance in concrete. Other advantages of the present invention include:

Sustainability: The use of recarbonated steel slag in the base layer promotes recycling and carbon sequestration, significantly reducing the environmental impact compared to traditional concrete pavers. Using recarbonated steel slag in place of virgin materials reduces the demand for mining and minimizes land use change, helping to conserve natural resources and reduce the carbon footprint of construction projects.

Reduction of Industrial Emissions: The recarbonation process can utilize CO₂ from direct air capture or industrial emissions, thereby contributing to the reduction of industrial carbon emissions.

Strength and Durability: The recarbonated steel slag base layer offers enhanced strength and durability, providing a robust foundation for the paver.

Aesthetic Versatility: The virgin concrete top layer can be customized to achieve various aesthetic effects, ensuring the paver meets specific design and architectural requirements.

Environmental Safety: The reduced permeability of the top layer prevents or retards the leaching of chemicals from the base layer, enhancing the environmental safety and longevity of the paver.

Long-Term Carbon Storage: The recarbonated steel slag base layer provides long-term storage of carbon, sequestering CO₂ absorbed during the recarbonation process.

Recyclability: The paver can be recycled into new concrete pavers, thereby providing a permanent carbon storage solution and further reducing the environmental impact.

Cost-Effectiveness: Utilizing industrial by-products like steel slag can reduce material costs and contribute to more economical construction solutions.

Manufacturing Flexibility: The ability to use either wet cast or dry cast methods provides flexibility in production, allowing for customization according to specific project requirements.

Sizing and Gradation: Processed steel slag can be sized and graded to meet specific requirements for different applications, just like virgin aggregates. However, recarbonated steel slag can offer a more uniform gradation and optimized particle distribution compared to some naturally mined aggregates, which can have varying sizes and shapes. This uniformity can improve the workability of concrete mixtures, leading to better compaction, density, and overall performance. Additionally, steel slag can be processed to produce a range of sizes suitable for different concrete applications, from fine aggregates for use in high-strength concrete to coarser aggregates for structural applications, providing flexibility that is comparable to or even better than naturally occurring aggregates.

Recarbonation Bond: The carbonated calcium (CaCO₃) and magnesium (MgCO₃) present in recarbonated steel slag form stable, inorganic carbonates that contribute to improved chemical bonding within concrete. These carbonates are more stable than uncarbonated calcium oxide (CaO) and magnesium oxide (MgO), reducing the risk of volume instability due to expansion or shrinkage. The bonding between the recarbonated slag and the cement matrix in concrete is enhanced compared to virgin aggregates, especially when the slag is finely processed. This improved chemical adhesion helps to increase the durability and long-term performance of concrete, as it is less susceptible to issues like alkali-silica reaction (ASR) or freeze-thaw damage. The carbonation of the slag also reduces the alkalinity of the material, which makes it less likely to react with harmful compounds in the concrete.

Recarbonated slag also contributes to the overall chemical resistance of concrete. Because the carbonated components are less reactive and more stable, concrete containing recarbonated steel slag is less likely to degrade when exposed to sulfates, chlorides, or other aggressive chemicals commonly found in environments such as seawater or industrial settings.

Cost-Effectiveness and Resource Efficiency: Using recarbonated steel slag also offers cost savings over time. As a byproduct of steelmaking, it is often more affordable than mining and processing virgin aggregates, and it reduces costs associated with landfilling steel slag, which otherwise requires environmentally costly disposal. Moreover, recycling steel slag and utilizing its carbonated forms in concrete reduces the dependency on virgin aggregates, which often require extraction, processing, and transportation from quarries, all of which incur additional environmental and financial costs.

In summary, using recarbonated steel slag processed to remove iron oxides as a concrete admixture represents an innovative and sustainable approach. It not only offers enhanced mechanical properties and durability but also contributes to environmental sustainability by repurposing industrial waste and potentially reducing the overall carbon footprint of concrete production.

The removal of iron oxides in the present process not only facilitates the local recarbonation of steel slag near the steel plant, but it also offers the potential to produce a valuable iron-oxide concentrate, which can be further processed into iron briquettes using both traditional and hydrogen reduction technologies. As mentioned, the removal of iron oxides from steel slag increases the reactivity of the remaining calcium oxide (CaO) and magnesium oxide (MgO), allowing for more efficient carbonation of the slag. This enables on-site recarbonation, eliminating the need for transportation to another location, thus making the process more economically and environmentally viable.

The removal of iron oxides during the slag processing produces a concentrated iron oxide fraction. This iron-oxide concentrate can be further processed into iron briquettes or other forms of iron feedstock. The reduction of iron oxides using either traditional blast furnace methods or hydrogen reduction technologies offers a sustainable alternative to traditional iron production methods, particularly in the case of hydrogen-based reduction, which reduces CO₂ emissions compared to conventional carbon-based methods.

Hydrogen reduction technologies present a green solution for converting iron oxide concentrates into iron briquettes. This method, which uses hydrogen gas instead of carbon, results in water vapor as a byproduct instead of CO₂, significantly reducing the carbon footprint of iron production. By removing iron oxides from steel slag, steel plants can generate high-quality iron-oxide concentrates that are suitable for hydrogen reduction, aligning with the growing interest in decarbonizing the steel industry.

Local recarbonation and the recovery of iron oxides for iron production offer economic advantages by reducing the need for external raw material sources and mining. Additionally, the hydrogen reduction of iron oxide concentrates creates a closed-loop process that minimizes waste and reduces the reliance on virgin iron ore, promoting a more sustainable approach to iron and steel production.

Although specific embodiments of the invention have been described in detail, it should be understood that the described embodiments are intended to be illustrative and not restrictive. Various changes and modifications of the embodiments shown in the drawings and described in the specification may be made within the scope of the following claims without departing from the scope of the invention in its broader aspect.

1. A composite concrete paver, comprising:
a base layer, comprising:
recarbonated steel slag;
a concrete mix;
wherein the recarbonated steel slag and the concrete mix are mixed to form a base layer mixture, which is uniformly distributed throughout the base layer.

2. The composite concrete paver of claim 1, further comprising a top layer comprising a virgin concrete product.

3. The composite concrete paver of claim 1, wherein the base layer comprises two or more sub-layers of different recarbonated steel slag compositions.

4. The composite concrete paver of claim 1, wherein an iron oxide, Fe₂O₃, content in the recarbonated steel slag is less than about 5% by mass.

5. The composite concrete paver of claim 1, wherein the recarbonated steel slag further comprises calcium carbonate, CaCO₃, in an amount from about 15% to about 25% by mass of a total concrete mix forming the composite concrete paver.

6. The composite concrete paver of claim 1, wherein the recarbonated steel slag further comprises magnesium carbonate, MgCO₃, in an amount from about 5% to about 10% by mass of a total concrete mix forming the composite concrete paver..

7. The composite concrete paver of claim 1, wherein the recarbonated steel slag further comprises silica, SiO₂, in an amount from about 10% to about 20% by mass of a total concrete mix forming the composite concrete paver..

8. The composite concrete paver of claim 1, wherein the recarbonated steel slag is from about 15% to about 30% by mass of the of a total concrete mix forming the composite concrete paver..

9. The composite concrete paver of claim 1, wherein:
the base layer is from about 10% to about 90% by weight of the composite concrete paver; and
the top layer makes up the balance to 100% by weight of the composite concrete paver.

10. The composite concrete paver of claim 9, wherein:
the base layer is from about 70% to about 80% by weight of the composite concrete paver; and
the top layer is from about 20% to about 30% by weight of the composite concrete paver.

11. The composite concrete paver of claim 1, having at least one of the following property:
capable of withstanding a compressive strength from 40 MPa to 60 MPa;
exhibiting a water absorption of 6% or less by mass.

12. The composite concrete paver of claim 2, wherein the top layer comprises Portland cement, fine aggregates having a particle size of 0-4 mm, coarse aggregates having a particle size of 4-10 mm, and water at a water-to-cement ratio of from about 0.08 to about 0.10.

13. The composite concrete paver of claim 1, wherein the base layer mixture further comprises one or more admixtures selected from the group consisting of fly ash, ground granulated blast furnace slag (GGBFS), silica fume, superplasticizers, air-entraining agents, hydrated lime, and polymer additives.

14. A method of manufacturing a composite concrete paver, comprising:
(a) crushing or granulating a steel slag to produce a pre-processed steel slag;
(b) reducing iron oxide content of the pre-processed slag to produce a refined steel slag, comprising calcium oxide;
(c) carbonating the refined steel slag, comprising exposing the refined steel slag to a carbon dioxide to cause a reaction of the calcium oxide with the carbon dioxide to form calcium carbonate, CaCO₃, thereby producing a recarbonated steel slag;
(d) forming a base layer of the composite concrete paver comprising the recarbonated steel slag.

15. The method of claim 14, wherein the step (d) further comprises forming a base layer comprising the recarbonated steel slag, and forming a top layer comprising a virgin concrete product.

16. The method of claim 14, wherein the forming the base layer further comprises forming two or more sub-layers of the base layer comprising different recarbonated steel slag compositions.

17. The method of claim 14, wherein the step (b) comprises reducing the iron oxide content to less than about 5% by mass of the recarbonated steel slag.

18. The method of claim 17, wherein the step (c) results in forming the calcium carbonate in an amount from about 15% to about 25% by mass of a total concrete mix forming the composite concrete paver.

19. The method of claim 14, wherein the refined steel slag further comprises magnesium oxide, and the step (c) further causes a reaction of the magnesium oxide with carbon dioxide to form magnesium carbonate, MgCO₃, in an amount from about 5% to about 10% by mass of a total concrete mix forming the composite concrete paver.

20. The method of claim 14, wherein the step (a) comprises reducing the steel slag to a particle size below about 100 μm.

21. The method of claim 14, wherein the step (d) comprises dry or wet moulding of the base layer followed by curing at a temperature of from about 20 °C to about 25 °C at a relative humidity from about 90% to about 95% for a period from about 7 to about 28 days.

22. The method of claim 14, wherein the step (b) comprises one or more of: magnetic separation;
physical gravity separation or sieving; and chemical leaching.

23. The method of claim 14, wherein, the carbon dioxide in the step (c) is sourced from direct air capture or from industrial process emissions.
